(19) United States
(12) Patent Application Publication
(10) Pub. No.: US 2007/0093996 A1
(43) Pub. Date: Apr. 26, 2007

(54) Formation prioritization optimization

(75) Inventors: Peter Thomas Cariveau, South Jordan, UT (US); Bala Durairajan, Houston, TX (US)

Correspondence Address: OSHA, LIANG LLP / SMITH, 1221 MCKINNEY STREET, SUITE 2800, HOUSTON, TX, 77010, US

(73) Assignee: Smith International, Inc., Houston, TX (US)

(21) Appl. No.: 11/583,668

(22) Filed: Oct. 19, 2006

Related U.S. Application Data
(60) Provisional application No. 60/729,902, filed on Oct. 25, 2005.

(51) Int. Cl. G06G 7/48

(52) U.S. Cl. 703/7

(57) ABSTRACT

A method for designing a drill bit including characterizing a plurality of formation segments, identifying relevant characteristics for drilling in the characterized formation segments, prioritizing at least two of the identified relevant characteristics based upon the characterizing of the formation segments, and selecting a drill bit design based upon the prioritizing.

### CROSS-REFERENCE TO RELATED APPLICATIONS

This application claims priority to U.S. Provisional Patent Application No. 60/729,902, filed Oct. 25, 2005.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

1. Field of the Invention

The invention relates generally to fixed cutter drill bits used to drill boreholes in subterranean formations. More specifically, the invention relates to methods for modeling, designing, and making a fixed cutter drill bit for optimized drilling performance through predetermined earth formations.

2. Background Art

Fixed cutter bits, such as PDC drill bits, are commonly used in the oil and gas industry to drill well bores. One example of a conventional drilling system for drilling boreholes in subsurface earth formations is shown in FIG. 1. This drilling system includes a drilling rig 10 used to turn a drill string 12 which extends downward into a well bore 14. Connected to the end of the drill string 12 is a bottomhole assembly (BHA) 18 that includes a fixed cutter drill bit 20.

A drilling tool assembly as shown in FIG. 1 above may be designed, modeled, or optimized in accordance with one or more embodiments of the invention. The drilling tool assembly includes a drill string 12 coupled to a BHA 18. The drill string 12 includes one or more joints of drill pipe. A drill string may further include additional components, such as tool joints, kellys, kelly cocks, kelly saver subs, blowout preventers, safety valves, and other components known in the art. The BHA 18 includes at least a drill bit 20. The BHA 18 may also include one or more drill collars, stabilizers, a downhole motor, MWD tools, and LWD tools, jars, accelerators, push the bit directional drilling tools, pull the bit directional drilling tools, point stab tools, shock absorbers, bent subs, pup joints, reamers, valves, and other components.

FIG. 2 shows a typical a fixed cutter drill bit 20. Such a drill bit 20 typically includes a bit body 22 having an externally threaded connection 24 at one end, and a plurality of blades 26 extending from the other end of bit body 22 and forming the cutting surface of the bit body 22. A plurality of cutters 28 are attached to each of the blades 26 and extend from the blades to cut through earth formations when the bit 20 is rotated during drilling. The cutters 28 deform the earth formation primarily by a combination of scraping and shearing. The cutters 28 may be tungsten carbide inserts, polycrystalline diamond compacts, milled steel teeth, or any other cutting elements of materials hard and strong enough to deform or cut through the formation. Hardfacing or polycrystalline diamond compacts (PDC) 29 are typically applied to the face of tungsten carbide insert cutters 28 to increase the life of the bit 20 as the bit 20 cuts through earth formations.

Significant expense is involved in the design and manufacture of drill bits and in the drilling of well bores. Having accurate models for predicting and analyzing drilling characteristics of bits can greatly reduce the cost associated with manufacturing drill bits and designing drilling operations because these models can be used to more accurately predict the performance of bits prior to their manufacture and/or use for a particular drilling application. For these reasons, models have been developed and employed for the analysis and design of fixed cutter drill bits.

Two of the most widely used methods for modeling the performance of fixed cutter bits or designing fixed cutter drill bits are disclosed in Sandia Report No. SAN86-1745 by David A. Glowka, printed September 1987 and titled “Development of a Method for Predicting the Performance and Wear of PDC drill Bits” and U.S. Pat. No. 4,815,342 to Bret, et al. and titled “Method for Modeling and Building Drill Bits,” and U.S. Pat. Nos. 5,010,789; 5,042,596, and 5,131,478 which are all incorporated herein by reference. While these models have been useful in that they provide a means for analyzing the forces acting on the bit, their accuracy as a reflection of drilling might be improved because these models rely on generalized theoretical approximations (typically some equations) of cutter and formation interaction. A good representation of the actual interactions between a particular drill bit and the particular formation to be drilled is useful for accurate modeling. The accuracy and applicability of assumptions made for all drill bits. All cutters and all earth formations can affect the accuracy of the prediction of the response of an actual drill bit drilling in an earth formation, even though the constants in the relationship are adjusted.

During drilling at a particular well site, a number of different types of earth and rock formations are likely to be encountered before reaching the oil bearing formation. In many instances, the type, hardness, or characteristics of the rock at a particular depth, and for a particular drilling distance, may be known from prior experience in the same oilfield or formation location. There is a continued need for drill bits that can perform sufficiently well in more than one formation type to penetrate to a designated depth at a desired overall rate prior to tripping the drill out of the well bore. There is a continued need for drill bits that have high performance for a depth of well bore to be drilled (TD).

### SUMMARY OF INVENTION

It has been found that a particular drill bit design can be selected for a particular formation in which the drilling is to take place based upon characterizing segments of the formation and prioritizing performance characteristics based upon the characterized formation segments. Thus, according to one embodiment the drill bit design is selected so that it is one that provides good performance according to the prioritization of two or more performance characteristics. For example, the selected drill bit design may be one known or expected to have excellent performance for the first priority performance characteristic when drilling in a formation of interest and very good performance for a second priority performance characteristic. In other embodiments, additional performance characteristics may be prioritized and a drill bit design may be selected based upon whether the selected design is expected to also have good performance corresponding to the additional prioritized performance characteristics.

It has also been found that a particular drill bit design can be optimized for a particular formation in which the drilling is to take place. The inventors have discovered according to one embodiment of the present invention that by prioritizing performance characteristics for identified formation segments one or more design parameters for a drill bit design may be improved or optimized according to the prioritization for drilling in the identified types and varieties of geological materials expected to be encountered in the formation of interest. For example data regarding the types of geological materials and formations expected at particular depths in a formation may be found in a well log for a previously drilled well in a particular field. Alternatively, similar formation specific data may be obtained from a variety of sources such as a well log for a well previously drilled at an adjacent location or from other sources. It has further been discovered by applicants that such formation specific information may be considered and the characteristics of formation segments may be identified as important or may be identified as potentially problematic for a drill bit designed to drill in such a formation. The identified characteristics can be prioritized in importance or can be used to prioritize desired performance characteristics useful for designing a drill bit to drill in the specific field of interest or in similar types of formations as those expected to be found in the field of interests. Thus, a drill bit design may be selected based upon the prioritized characteristics. A drill bit design may also be improved or optimized based upon the prioritized characteristics.

In one embodiment the prioritized characteristics may be performance characteristics. A drill bit design may be based upon the prioritized characteristics. The drill bit design may also be modeled and/or drilling with the selected drill bit design may be simulated to determine performance with respect to the prioritized characteristics.

In the selecting and/or improving of a drill bit design all the prioritized characteristics may be considered, the highest priority characteristics may be considered more than lower priority characteristics, and other characteristics may be considered less or may be disregarded in favor of the prioritized characteristics.

In one embodiment design characteristics may be modified to improve the performance of the drill bit design with respect to characterized formation segments and prioritized performance characteristics for drilling in such formation segments.

In one embodiment the drill bit design characteristics may also be prioritized in importance for the design process and the drill bit design can be optimized with respect to the prioritized formation characteristics, the prioritized performance characteristics, and/or the prioritized drill bit design characteristics. Thus, an effective drill bit design may be obtained for a drill bit and a drill bit according to such a drill bit design can be made that is particularly suited for drilling the particular formation of interest.

Other aspects and advantages of the invention will be apparent from the following description and the appended claims. For example, in various embodiments operational characteristics for a drill bit or for a drill string might be considered as variables that can be modified to affect the drill bit performance. In various embodiments operational characteristics might be established as constraints placed upon modeling and simulating the drill bit performance during the design process to thereby facilitate improving or optimizing the drill bit design for a particular drilling operation in formation segments of interests.

### BRIEF DESCRIPTION OF DRAWINGS

FIG. 1 shows a schematic diagram of a conventional drilling system for drilling earth formations.

FIG. 2 shows a perspective view of a prior art fixed-cutter bit.

FIG. 3 shows a schematic flow diagram for a method of selecting a design of a drill bit according to one embodiment of the invention.

FIG. 4 shows a diagram of an example portion of a drilling log for a formation with first, second, and third formation segments of interest for drilling.

FIG. 5 shows a schematic flow diagram of an embodiment of a method for designing a drill bit according to prioritized performance characteristics and within established constraints.

FIG. 6 shows a schematic flow diagram of an embodiment of a method for designing a drill bit for improved performance according to prioritized performance characteristics.

FIG. 7 shows a diagram of another example portion of a drilling log for a formation with first, second, and third formation segments of interest for drilling.

FIG. 8 shows an end view of one example of a fixed cutter drill bit design that may be selected, improved, optimized, and/or made according to the invention.

FIG. 9 shows an end view of another example of a fixed cutter drill bit design that may be selected, improved, optimized, and/or made according to the invention.

FIG. 10 shows an end view of another example of a fixed cutter drill bit design that may be selected, improved, optimized, and/or made according to the invention.

FIG. 11 shows a diagram of simulated wear flat area representing abrasion resistance performance for the drill bit designs of FIGS. 8, 9, and 10.

FIG. 12 shows a diagram of simulated footage analysis representing ROP and durability performance for the drill bit designs of FIGS. 8, 9, and 10.

FIG. 13 shows an end view of a simulated bottomhole drilling pattern representing stability performance for one example of a fixed cutter drill bit design of FIG. 8.

FIG. 14 shows an end view of a simulated bottomhole drilling pattern representing stability performance for one example of a fixed cutter drill bit design of FIG. 9.

FIG. 15 shows an end view of a simulated bottomhole drilling pattern representing stability performance for one example of a fixed cutter drill bit design of FIG. 9.

### DETAILED DESCRIPTION

The present invention provides a method for designing a drill bit and drill bits designed according to the method. The drill bit designing method also uses methods for modeling drill bit designs and determining the response of a drilling tool assembly in a particular earth formation of interest to advantageously design a drill bit for the drilling tool that is useful for drilling in the formation of interest. Aspects of known methods are used in combination with other aspects of the invention including characterizing formation segments to be drilled and prioritizing certain performance characteristics of a drill bit in formations having the same or similar characteristics of the formation to be drilled to provide the useful drill bit designs.

Examples of methods for modeling drill bits are known in the art, see for example U.S. Pat. No. 6,516,293 to Huang, U.S. Pat. No. 6,213,225 to Chen for roller cone bits, and U.S. Pat. No. 4,815,342; U.S. Pat. No. 5,010,789; U.S. Pat. No. 5,042,596; and U.S. Pat. No. 5,131,479, each to Brett et al. for fixed cutter bits, which are each hereby incorporated by reference in their entireties. For example, methods for determining the response of a drilling tool assembly to drilling interaction with an earth formation were disclosed in U.S. Pat. No. 6,785,641 by Huang, which is assigned to the assignee of the present invention and incorporated herein by reference in its entirety. New methods developed for modeling, designing, and optimizing fixed cutter drill bits are also disclosed in U.S. Patent Application No. 60/485,642 by Huang, filed on Jul. 9, 2003, titled “Method for Modeling, Designing, and Optimizing Fixed Cutter Bits,” assigned to the assignee of the present application and incorporated herein by reference in its entirety, and other methods disclosed in U.S. patent application Ser. No. 10/888,523, filed on Jul. 9, 2004, titled “Methods For Designing Fixed Cutter Bits and Bits Made Using Such Methods”, U.S. patent application Ser. No. 10/888,358, filed on Jul. 9, 2004, titled “Methods For Modeling, Displaying, Designing, and Optimizing Fixed Cutter Bits”, U.S. patent application Ser. No. 10/888,354, filed on Jul. 9, 2004, titled “Methods for Modeling Wear of Fixed Cutter Bits and for Designing and Optimizing Fixed Cutter Bits”, and U.S. patent application Ser. No. 10/888,446, filed on Jul. 9, 2004, titled “Methods For Modeling, Designing, and Optimizing Drilling Tool Assemblies”, all incorporated herein by reference.

Methods disclosed in such incorporated patents and applications may advantageously allow for accurate prediction of the actual performance of a fixed cutter bit drilling in characterized formation segments by incorporating the use of actual cutting element/earth formation interaction data or related empirical formulas to accurately predict the interaction between cutting elements and earth formations during drilling.

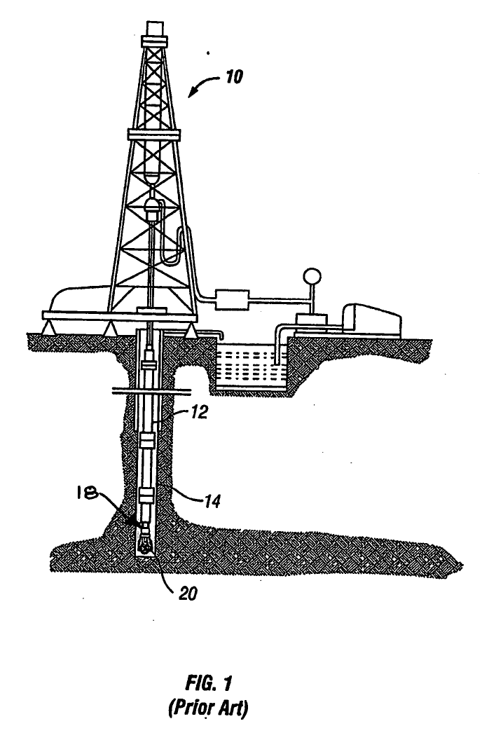

To simulate the dynamic response of a drilling tool assembly, such as the one shown in FIG. 1, components of the drilling tool assembly may need to be defined. For example, the drill string may be defined in terms of geometric and material parameters, such as the total length, the total weight, inside diameter (ID), outside diameter (OD), and material properties of each of the various components that make up the drill string. Material properties of the drill string components may include the strength and elasticity of the component material. Each component of the drill string may be individually defined or various parts may be defined in the aggregate. For example, a drill string comprising a plurality of substantially identical joints of drill pipe may be defined by the number of drill pipe joints of the drill string, and the ID, OD, length, and material properties for one drill pipe joint. Similarly, the BHA may be defined in terms of geometrical and material parameters of each component of the BHA, such as the ID, OD, length, location, and material properties of each component. Geometry and material properties of the drill bit may also be defined as required for the method used to simulate drill bit interaction with earth formation at the bottom surface of the wellbore.

While in practice, a BHA comprises a drill bit, in embodiments of the invention described below, the parameters of the drill bit design that are required for modeling interaction between the drill bit and the bottomhole surface, are generally considered separately from the BHA parameters. This separate consideration of the drill bit allows for interchangeable use of any drill bit model as determined by the system designer in any BHA or any drill string design.

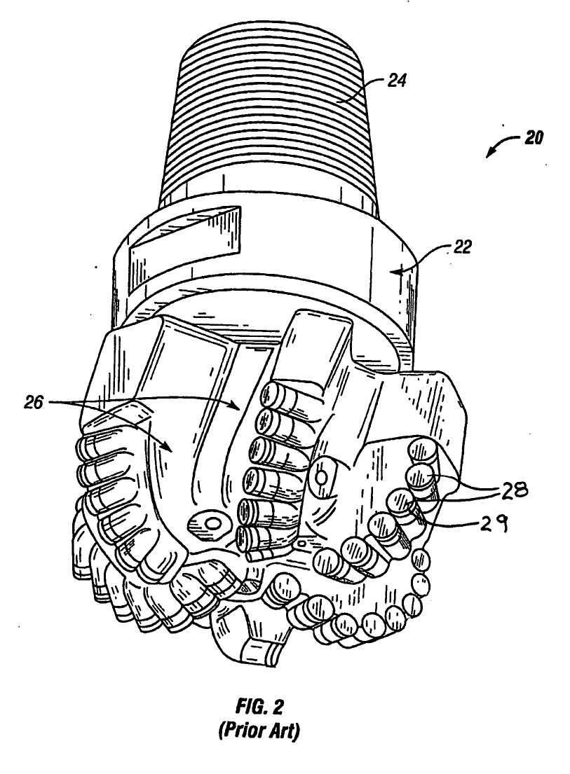

It has been discovered by applicants that designing a fixed cutter drill bit 20, such as the one shown in FIG. 2, for drilling in a plurality identified formations having identifiable characteristics can be usefully achieved by incorporating a unique method that includes prioritizing one or more characteristics of the formation, of the drilling tool design, and/or of the interaction of certain design parameters with the characteristics of the formation.

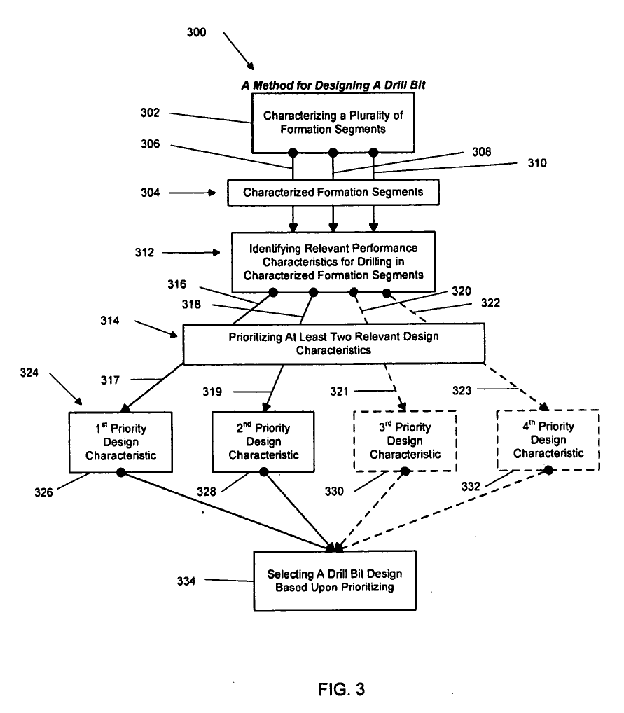

FIG. 3 shows a flow chart of a method 300 for designing a drill bit. The method according to this embodiment of the invention includes characterizing a plurality of formation segments at 302.

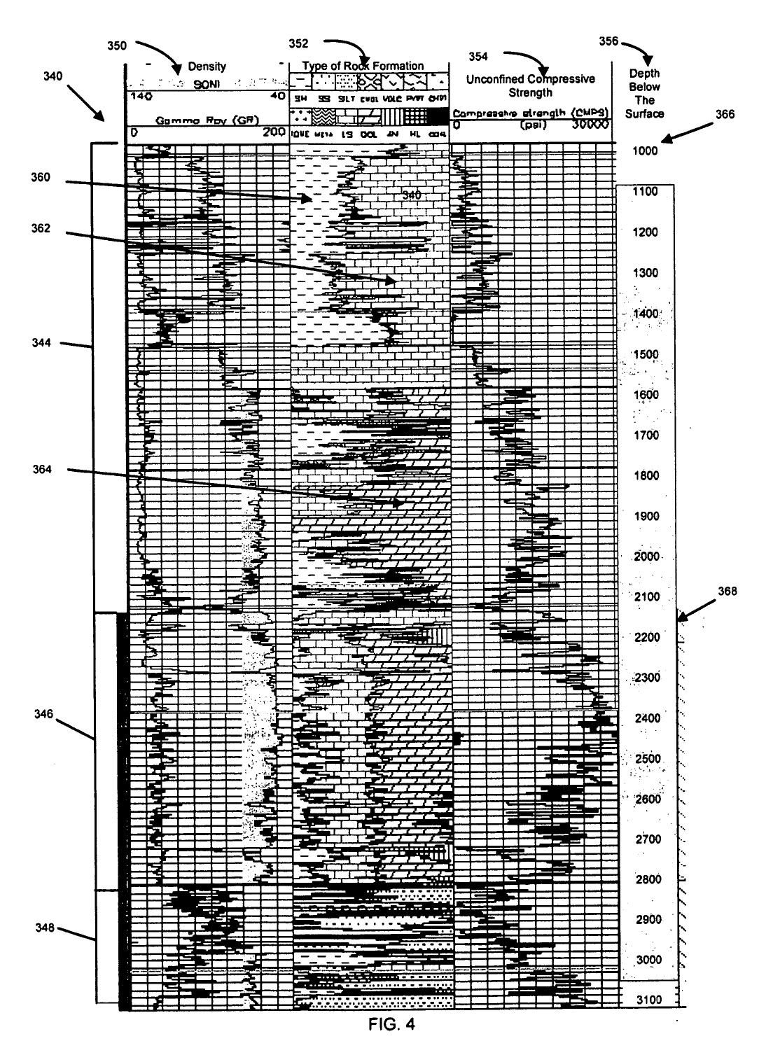

FIG. 4 shows a well log record 340 in the form of a formation record for a specific example formation of interest.

With reference to FIG. 3 and also to FIG. 4, characterization 302 of the formation segments can be provided based upon company specific record such as a formation record, oil field drilling operator bit run records, governmental or customer formation data, experimental data for formations of the type expected to be encountered, and other well data in the same or similar drilling field. As will be understood by those of ordinary skill in the art based upon this disclosure and as more fully disclosed below, the specific formation data for a formation of interest may be taken alone from a given drilling record or may be taken together from a variety of sources to characterize specific segments of a formation such as rock strength, hardness, abrasiveness, drill dulling effects, orientation thickness, transitions angles, resistance to drilling, drilling stability, and etc.

Referring again to FIG. 3, the characterized formation segments at 304 may include several characterized formation segments represented as lines 306, 308, and 310. Performance characteristics 314, 316, 318, and 320 are identified at 312, as being relevant for drilling in the characterized formation segments 306, 308, and 310. It will be understood that the characterizations of the formation segments may selected or chosen from among those indicated in Table II below or from others as might be recognized by those skilled in the art. The relevant performance characteristics 314, 316, 318, and 320 for the characterized formation segments 306, 308, and 310 may be selected or chosen from those set forth in Table III or from others that might be recognized by those skilled in the art. It will further be understood that while FIG. 3 depicts several formation segments and several relevant performance characteristics, a different number of such formation segments and relevant performance characteristics may be characterized and identified without departing from certain aspects of the invention.

The identification of the relevant performance characteristics 312 can for example be based upon historical data or experimental data by which previous analyses or experiments have indicated a correlation between certain identified formation segment characteristics and desired performance of a drill bit drilling in such identified and characterized formation segments. In another example, the identifying 312 of performance characteristics relevant to the drilling in the characterized formation segments may be facilitated by using a known drill bit dull analysis associated with a known drill bit when drilling in the same or similar formation segments. With the resultant relevant performance characteristics identified the relevant performance characteristics are prioritized at 314 on the basis of importance for drilling in the characterized formation segments. In various examples the identification may be provided for use by being displayed, placed in an electronic data storage medium, output to another document, or otherwise provided in another useful form. Thus, for example, the importance of one relevant performance characteristic 316 is prioritized at 314 relative to another performance characteristic 318 based upon the characterized formation segments 306, 308, and 310. For example, the importance of a stability performance characteristic 316 may be higher than the importance of an abrasion resistance performance characteristic 318, where the characteristic of a long formation segment comprises hard rock while a shorter formation segment comprises abrasive sandstone. According to one embodiment the relative importance of any or all of the relevant performance characteristics 316, 318, 320, and 322 may also be prioritized relative to each other to provide resultant priority characteristics 317, 319, 321, and 323. It should be noted that the priority characteristics 317, 319, 321, and 323 need not be in the same order as the identified relevant performance characteristics 316, 318, 320, and 322. The prioritized relevant performance characteristics are thus established according to their priority at 324, for example so that at least two priorities 326 and 328 are set. Additional priorities for additional identified relevant performance characteristics may also be set 330 and 332 may also be set. It will also be understood that the order of the prioritized characteristics 326, 328, 333, and 332 will depend upon the importance of the performance characteristic and need not be the same order as depicted for the relevant performance characteristics 316, 318, 320, and 322.

It should also be noted that according to one embodiment, one or more of the priorities might be of substantially equal importance relative to one or more other prioritized characteristics. In this embodiment prioritizing may be considered based upon priority relative to other characteristics that are not among such one or more other prioritized characteristics.

Based upon the prioritizing of the performance characteristics and the resulting priorities, a bit design is selected at 334. For example, a drill bit design may be selected as a design known to have excellent stability performance characteristics 326 and also one that has good abrasion resistance characteristics 328 so that the selected design is one that provides both aspects of the first and second prioritized performance characteristics 326 and 328. The selection may be based upon known or developed relationships correlating certain drill bit designs to expected performance characteristics for such drill bit designs. Moreover, according to one embodiment a database of stored drill bit designs and stored expected performance characteristics associated with the stored drill bit designs may be used in a computer appropriately programmed to select the drill bit design according to the prioritized performance characteristics.

A plurality of segments 306, 308, and 310 of the earth formation of interest may include, for example, a series of segments of formations to be drilled in a particular formation or field. Information by which such formation segments can be characterized at 304 may be obtained from a number of possible sources. For example, a company specific record such as a formation record can provide useful information. Other sources of useful information may include drill bit run records, oil field drilling operator records, governmental formation records, customer formation data, experimental data for formations of the type expected to be encountered, and other well data in the same or similar drilling field of interest taken alone, taken in combinations, or taken together with experimental or laboratory test data to provide rock strength, hardness, abrasiveness, drill dulling effects, orientation thickness, transitions angles, resistance to drilling, drilling stability, and etc. FIG. 4 show a formation record 340 obtained for an example formation of interest 342. In this example there are identified formation segments including a first segment 344, a second segment 346, and a third segment 348 designated generally as different segment based upon general differences in characteristics of the identified formation segments. In this diagram the results of various wave form investigations such as sonic and gamma rays are shown in a column at 350 to help indicate material characteristics such as density of the rock formation at certain depths. The predicted types of rock or formation are shown along column 352, The compressive strengths of the formation segments are shown along a column at 354. The corresponding depths are shown along the formation at column 356. In this example of a formation record, the first section 344 is depicted consisting of limestone 360, dolomite 362, and shale 364 extending from a depth 366 of about 1000 feet below the surface to a depth 368 of about 2100 feet below the surface. The density or other general physical condition or characteristic of the formation, as might be understood according to the wave investigation 350, the type of rock, as indicated at 352, and the unconfined compressive strengths (UCS), as indicated at 354, for the identified formation segments at various locations along the wellbore at depths, as indicated at 356, can be used to characterize the formation segments 344, 346, and 348 as described with respect to the method shown in FIG. 3 above, at the characterizing step 304. In the first segment 344, the density is relatively low; the rock type is limestone, dolomite and shale, and the unconfined compressive strength (UCS) ranges from a few thousand psi up to about 20,000 psi. A second section 346 generally consist of extremely hard and interbedded dolomite in a limestone shale formation extending from about 2000 feet deep to about 2800 feet deep. The unconfined compressive strength ranges from about 10,000 psi UCS up to about 30,000 psi UCS. A third section 348 consists of abrasive sandstone extending from about 2800 feet deep to about 3200 feet deep. The unconfined compressive strength varies from a few thousand psi up to about 25,000 psi.

One formation characteristic that can be important to various performance characteristics is the unconfined compressive strength (UCS) indicated at 354. Because of the high UCS of second segment 346 of the formation of interest (which high UCS is consistent with both the generally high density and with the types of rock in the second segment of the formation), the stability performance characteristic of a drill bit design is considered very important. If the drill bit does not maintain stable drilling in this hard dense formation segment, the cutters on the drill bit will be likely to chip and as a result the drill bit will likely fail to complete drilling to the dept required (TD).

In this example, another formation characteristic of importance is the extended length of softer material in the first segment 344. Thus, a performance characteristic of importance for the first segment 344 is the rate of penetration (ROP). In order to complete the drilling in a reasonable time and to avoid undue dwelling in the generally softer and less dense rock types in the first section 344, a drill bit design capable of a reasonably fast ROP is important. The unconfined compressive strength of the sandstone in the third segment 346 ranges from a few thousand psi to about 25,000 psi; however, it is generally or on an average less than about 15,000 psi. The performance characteristic that might be identified as important for this segment 348 is abrasion resistance or wear resistance. If the drill bit design survives the destructive high strength formation segment 346 after having traversed the entire depth of the first segment 344, it must still avoid having wear flat areas on the cutters that could cause it to fail due to wear in the third section 348 characterized by high abrasion or high wear.

Thus, according to one embodiment of the method shown in FIG. 3 and with reference to the example formation of interest 340 of FIG. 4, a drill bit design is selected based upon the prioritizing of performance characteristics. In the example of FIG. 4, stability in the hard second segment 346 is prioritized as the first priority performance characteristic 326 (FIG. 3). A good rate of penetration (ROP) in the first segment 344 (FIG. 4) is prioritized as the second priority 328 (FIG. 3). Wear resistance in the third formation segment 348 is established as a third priority performance characteristic. To select a drill bit based upon the priorities in this example, a drill bit design may be selected that has cutters positioned with a non-aggressive back rack angle to facilitate stable drilling while permitting a sufficient ROP. The drill bit design may also be selected that has a single set cutter blade arrangement that will provide relatively smaller and less aggressive depth of cut for each cutter thereby increasing the durability in the hard formations while still permitting an acceptably rapid ROP. The single set may also provide maximum side contact for increased stability in the hard formation segment. In order to increase the wear resistance, larger diameter cutters may be used. For larger diameter cutters it has been shown that for the same amount of wear on the PDC cutters, the percentage of the worn PDC area is less. Larger cutters, therefore, retain strength and avoid failure due to wear for a longer period of drilling than smaller cutters. This permits the drill bit to continue drilling into the abrasive formation even after the first and second formation segments are drilled. Thus, a drill bit design is selected based upon the prioritizing.

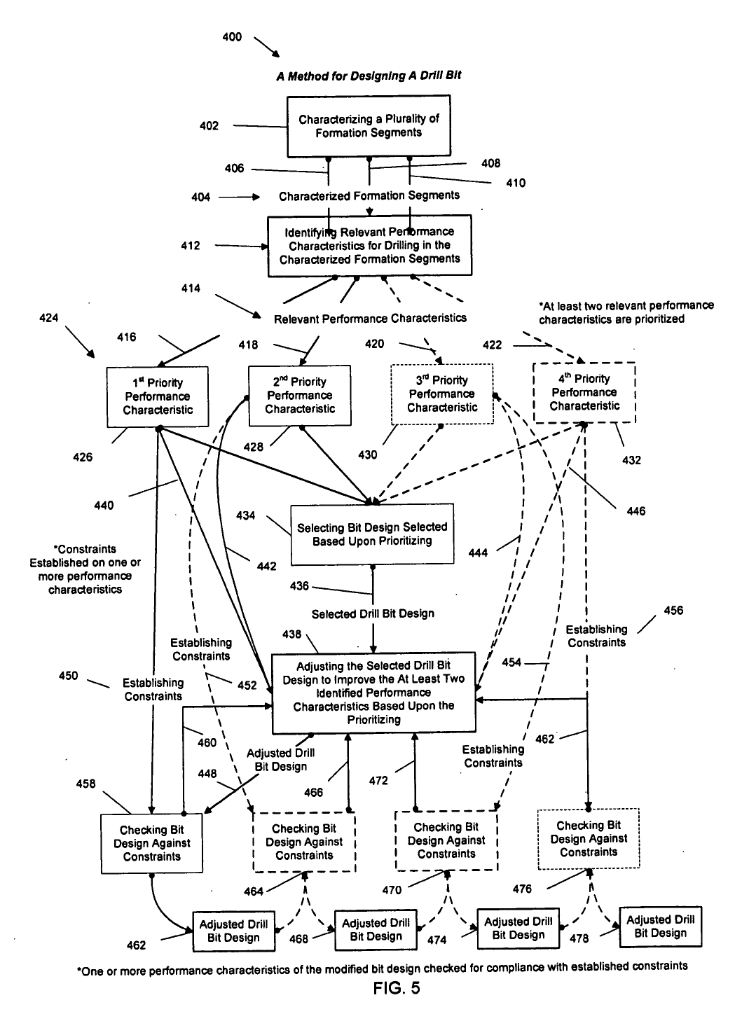

FIG. 5 shows a flow diagram of an alternative method 400 for designing a drill bit including characterizing 402 a plurality 404 of formation segments 406, 408, and 410, identifying 412 a plurality 414 of relevant performance characteristics 416, 418, and 420 for drilling in the characterized formation segments 406, 408, and 410, prioritizing 424 at least two of the identified relevant performance characteristics 416, 418, and 420 based upon the characterized formation segments, selecting a bit design 434 based upon the prioritizing, and modifying or adjusting 438 the selected drill bit design 436 to improve at least two identified performance characteristics, for example to improve at least performance characteristics 426 and 428, based upon the prioritizing of relevant performance characteristics.

FIG. 5 further shows adjusting the drill bit design iteratively to improve the design for improved performance 440 of the first priority performance characteristic and then adjusting the drill bit design to improve performance 442 of the second priority performance characteristic. The adjusting of the drill bit design to improve the performance 440 and 442 are repeated until the relative performance of the first priority performance characteristic 426 and the second priority performance characteristic 428 are improved according to the priority order. In one embodiment the performances of at least two performance characteristics, 426 and 428 in this example, are optimized primarily with respect to the first priority and then with respect to the second priority.

In one alternative embodiment a plurality of priorities are established for relevant performance characteristics 426, 428, 430, and 432. The drill bit design is adjusted iteratively to improve the design for improved performances 440, 442, 444, 446, and any additional performances for the first priority performance characteristic 426, the second priority performance characteristic 428, the third priority performance characteristic 430, the fourth priority performance characteristic 432, and any additional priority performance characteristics, respectively. The adjusting of the drill bit design to improve the performances 440, 442, 444, 446, and any additional performances are repeated until the relative performance of the first priority performance characteristic 426, the second priority performance characteristic 428, the third priority performance characteristic 430, the fourth priority performance characteristic 432, and any additional priority performance characteristics are improved according to the priority order. In one embodiment the performances of performance characteristics, 426, 428, 430, and 432 in this example, are optimized primarily with respect to the first priority and then with respect to the second, then with respect to the third and then with respect to the fourth priorities.

FIG. 5 further shows an embodiment of a method according to the invention including establishing at least one constraints, for example establishing constraints at 450. In some embodiments the method may include establishing second constraints 452, and in alternative embodiments a plurality of other constraints 454, and 456. The constraints may be any one or more of a number of parameters that might include certain minimum desired performance criteria or parameters that might not be adjustable in a specific well drilling environment. For example the constraints might include a minimum performance criteria such as rate of penetration within a range of 20-40 meters per hour. The constraints might also be a drill bit design characteristic such as a particular drill bit size, the constraints might be a particular operating parameter, such as drilling rotation speed within a range of 100-200 RPM, or the constraints might include a drill string feature such a down hole motor drive. One or a plurality of such constraints might be established. The method may also include checking at 458 the one or more performance characteristics of the adjusted bit design for compliance with the established first constraints 450. For example, according to one embodiment, if the first constraints 450 include a desired or minimum performance criteria for the first priority performance characteristic 426, and the adjusted design 448 does not meet or exceed the level of performance established as a constraint, the drill bit design is returned at 460 for further adjusting at 438 of a drill bit design parameter. The adjusted design 448 is again checked at 458 against the first constraints 450 and the loop of adjusting and checking is repeated until the adjusted drill bit design 462 meets the criteria of the constraints.

If second constraints 452 are established for the second priority 428, the adjusted drill bit design 462 that meets the first priority constraint 450 is checked at 464 against the second established constraints 452. If the constraints are not met then the drill bit design “returns” 466 for adjusting of a drill bit design parameter at 438. The adjusted drill bit design is then checked at 458 against the first priority constraints 450. If it does not meet the first constraints the design is returned to adjusting at 460. If it meets the first constraints it is checked again at 464 against the second constraints 452. This process loop is repeated until the constraints are acceptably meet for both the first and the second priorities.

Similarly, if third constraints 454 are established relative to the third priority performance characteristic 430, the adjusted drill bit design 468 can be repeatedly and sequentially checked at 470, returned at 472 to be adjusted at 438, and checked at 458, 464, and 470 repeatedly. Also similarly, if fourth and additional constraints are established, the adjusted drill bit design 474 can be checked at 476, returned at 462, adjusted at 438, and checked at 458, 464, 470, and 476 repeatedly until an adjusted drill bit design 478 is obtained that meets all the established constraints 450, 452, 454, and 456 and obtains improvement in performance with respect to the first, second, third, fourth, and/or etc. priorities 450, 452, 454, and/or 456, respectively.

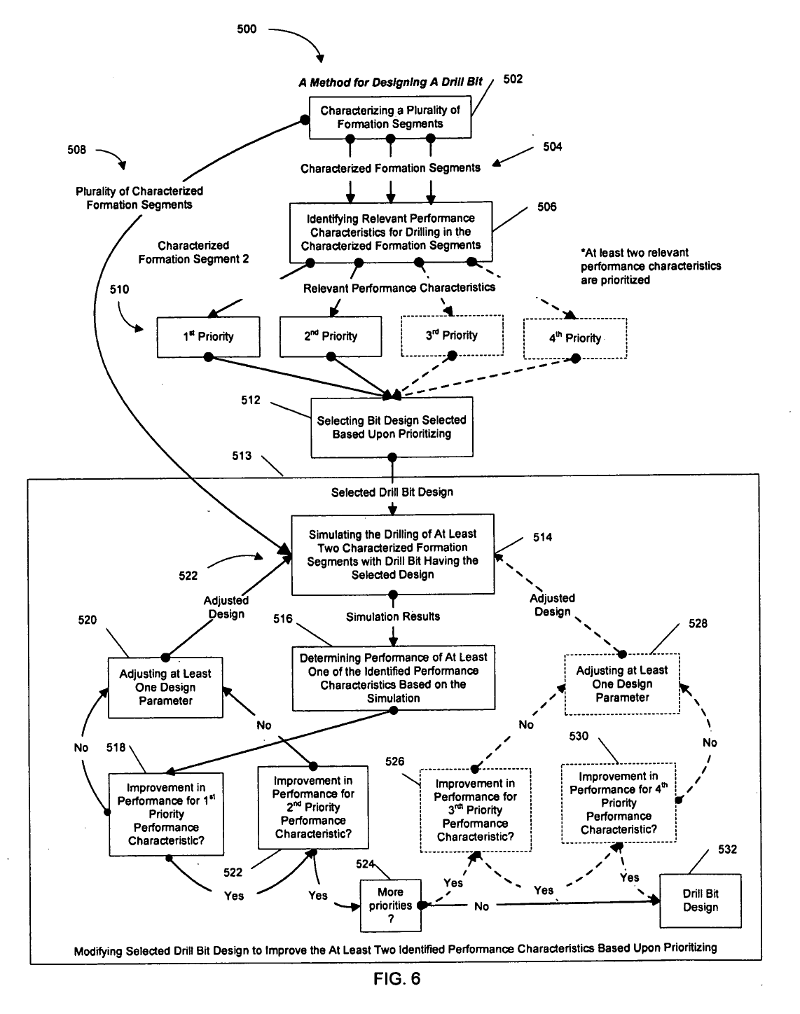

FIG. 6 shows a flow diagram of an alternative method 500 including characterizing 502 a plurality of formation segments 504, identifying 506 relevant performance characteristics for drilling in the characterized formation segments, prioritizing 510 at least two of the identified relevant performance characteristics based upon the characterization of the formation segments, selecting 512 a bit design based upon the prioritizing 510, and modifying 513 the selected drill bit design by simulating 514 the drilling of the at least two characterized formation segments with a drill bit having the selected design, determining 516 performance for at least two of the identified performance characteristics 511 based upon the simulation 514, checking 518 for improvement in the performance of the least two identified performance characteristic; adjusting 520 at least one design parameter to provide an adjusted design, and repeating 522 the simulating 514, the determining 516, the checking 518, and the adjusting 520 at least until performances of the at least two prioritized performance characteristic are improved according to the prioritizing 510. It will be noted according to one embodiment as depicted that after checking at 518 indicates an appropriate improvement has been achieved in the performance for the first priority performance characteristic, that checking for improvement in the performance for the second priority performance characteristic is checked. If there is no improvement in the second priority performance then at least one design parameter is adjusted and the process is repeated until both the first and the second priority performance characteristics are improved. If there are no more priorities to consider at 524, the drill bit design 532 is the output result.

In one embodiment, priorities are established for a plurality of relevant performance characteristics among the identified relevant performance characteristics for the characterized formation segments to be drilled. In such an embodiment the same process is followed until after the first and second priority performances are adequately improved and finding more priorities at 524, the performance of the third priority performance characteristic is checked 526 for improvement. If there has also been adequate improvement 526, the performance relative to any subsequent priority performance characteristic such as the fourth priority performance characteristic is checked 530. If there has been adequate improvement, a drill bit design 532 results. If there has not been adequate improvement in the performance of the third, the fourth or subsequent priority performance characteristics then at least one design parameter is adjusted 528 and the simulating, determining checking, and adjusting are repeated until performance of all the all of the priority performance characteristics are adequately improved. In one example, adequate improvement may require improvement of at least the first priority performance characteristic, less improvement in the second performance characteristic, less improvement in the third priority performance characteristic and less improvement in the fourth or in subsequent priority performance characteristics.

In another embodiment, the improvement in the performance of the priority performance characteristics might be determined by establishing constraints on one or more performance characteristics, checking the performance for one or more performance characteristics of the modified bit design for compliance with the established constraints, and repeating the simulating, determining, checking for compliance with the established constraints and adjusting at least until performances of the one or more performance characteristics are in compliance with the established constraints.

The characterization of the formation segments may include characterizing the formation segments for a drilling field of interest based upon one or more of the group comprising formation records, bit run records, customer formation data, experimental data, and other well data in the same or similar drilling field of interest. The formation segments may for example be characterized as one or more of the group of characterizations including hard formation, medium hard formation, soft formation, abrasive formation, medium hard and abrasive formation, soft and abrasive formation, transition formation, and conglomerate formation. The characterization of the formation segments might also include determining the proportion of a drilling run that will be one or more of the group of hard formation, medium hard formation, soft formation, abrasive formation, medium hard and abrasive formation, soft and abrasive formation, transition formation, and conglomerate formation.

The at least two relevant performance characteristics may be selected from among the group of stability, wear, peak loads, and drilling deviation and/or particular drilling modeling responses indicative of one or more of those performance characteristics.

The identification of relevant performance characteristics may include identification of one or more of the group selected from wear patterns, historical failure modes, dull bit grading, stability analysis, impact loads, peak cutter loads, rate of penetration (ROP), rotation speed (RPM), and depth of cut (DOC).

According to one embodiment a method of designing a drill bit includes selecting an initial drill bit design, characterizing a plurality of formation segments for a formation of interest, identifying at least two relevant performance characteristics for drilling in the characterized formation segments, prioritizing the at least two relevant performance characteristics based upon the characterization of the formation segments, and modifying the selected bit design based upon the prioritizing to obtain a drill bit design that will be useful for drilling in the prioritized formation segments. In one embodiment the drill bit design can be optimized for drilling in all of the identified formation segments to be drilled.

According to another embodiment a method of planning well drilling includes characterizing a plurality of formation segments, identifying relevant performance characteristics for drilling in the characterized formation segments, prioritizing at least two of the identified relevant performance characteristics based upon the characterization of the formation segments, and selecting at least one bit design based upon the prioritizing.

According to one embodiment the selecting the at least one drill bit based upon the prioritizing in the method of planning well drilling also includes selecting more than one drill bit design and determining a sequence of drilling with the selected more than one drill bit design to improve the at least two relevant performance characteristics during drilling.

According to another embodiment a system for prioritizing formation characteristics includes storing formation type identifications on a database, storing previously prioritized performance characteristics for the identified formation types on a database, storing drill bit designs previously optimized for the prioritized performance characteristics, matching input formation type identifications with the prioritized characteristics and with the drill bit designs, and outputting at least one matched drill bit design.

Embodiments of the present invention are useful to provide the ability to model inhomogeneous regions and transitions between layers. With respect to inhomogeneous regions, sections of formation may be modeled as nodules or beams of different material embedded into a base material, for example. That is, a user may define a section of a formation as including various non-uniform regions, whereby several different types of rock are included as discrete regions within a single section.

The modeling of a drill bit design might be performed with controls placed upon different model type parameters. The earth formation characteristics for a formation of interest are identified as existing in a particular formation, namely the formation to be drilled and thus the formation in which the drilling would be modeled.

In one embodiment a cutter/formation control model can be usefully employed. Other examples of model types that might be employed for modeling the drilling in a formation of interest are also set forth in Table I below.

TABLE I
Control model type parameters:

1) cutter/formation control model,
2) weight on bit (WOB) control model,
3) rate of penetration control (ROP) control model,
4) constrained centerline control model, and
5) dynamic model.

According to one embodiment the method of designing a fixed cutter drill bit includes optimization of the drill bit design based upon prioritizing or otherwise ranking of two or more formation parameters affecting one or more drilling performance criteria.

The two or more formation parameters may for example be selected from the group consisting of formation layer type, formation layer depth, formation mechanical strength, formation density, formation wear characteristics, formation homogeneity (homogeneous formation), formation non-homogeneity (conglomeration), anisotropic orientation, multiple layer formation interfaces, borehole diameter, formation layer interface dip angle, formation layer interface strike angle, empirical test data for earth formation type, and empirical test data for multiple layer interface. These examples of earth formation characteristics are set forth in Table II below.

TABLE II
Earth formation characteristics:

```
  1) formation layer type,
  2) formation layer depth,
  3) formation mechanical strength,
  4) formation density,
  5) ?Formation unconfined compressive strength (UCS)
  6) formation homogeneity (homogeneous formation),
  7) formation non-homogeneity (conglomeration),
  8) anisotropic orientation,
  9) multiple layer formation interfaces,
10) borehole diameter,
11) formation layer interface dip angle,
12) formation layer interface strike angle,
13) empirical test data for earth formation type, and
14) empirical test data for multiple layer interface.
```

According to one embodiment two or more of such formation characteristics are identified and prioritized according to expected importance for optimizing drilling. Some of the factors that could influence the expected importance may include the type of bit employed, the depth or expected drilling duration for such formation characteristic, the drill bit design, the drill string design, drilling operation parameters, and the sequence of occurrence of such formation characteristics during drilling. The user may also select and define the characteristics of the formation that are important to successful drilling and drill bit design by considering the well survey data and wellbore data. For example, for each segment a user may define the measured depth, inclination angle, and azimuth angle of each segment of the wellbore, and the diameter, well stiffness, coefficient of restitution, axial and transverse damping coefficients of friction, axial and transverse scraping coefficient of friction.

Examples of identifying formation characteristics and prioritizing of the identified formation characteristics will be provided in the EXAMPLES Section below. Those of ordinary skill in the art, upon understanding the invention disclosed herein and the examples of implementing the invention described in this disclosure, will also understand that these factors are examples only and that there can be other factors that might influence prioritizing depending upon the formation of interest and the drilling system involved.

In various embodiments, the characteristics of interest in a particular formation may be identified from one or more of a well log, a bit run record, a company specific formation record, customer information data, experimental data obtained for similar formation types, and other well data in the same field or formation of interest or in similar or adjacent fields that might be presumed to be similar until other records are obtained.

A prioritization may for example be one that specifically focuses on two characterized formation segments and two performance characteristics prioritized based upon the characterized formation segments. For example, a hard formation and an abrasive formation such that the prioritized performance characteristics might be an overriding need for stability in the hard formation and a secondary need for wear resistance in the abrasive formation.

Another prioritization may for example be one that specifically includes several formation segments and gives additional emphasis to performance that could be important in two or more formation segments. For example, in a hard formation segment there may be an need for stability, in a very long section of a soft formation there may be a need for rapid drilling or a high ROP in order to be competitive with other available drill bits, and in another section with a conglomerated soft material with hard materials interspersed such that stability is also needed. Thus, even though the soft material might be a significantly larger percentage of the depth to be drilled the stability performance characteristic might be prioritized as the first priority and the rapid ROP the second priority.

The prioritization formula may be the same for a plurality of known layers of the formation and may be prioritized based upon the highest frequency of occurrence of a particular type or characteristic of the formation.

In one alternative embodiment one or more drill bit designs may be modeled based upon the characterization of two or more of earth formation parameters or drill bit/formation interface configuration parameters with drilling operating parameters constrained to certain achievable or advantageous operating parameters or within ranges of achievable or advantageous operating parameters and prioritization of performance characteristics based upon the characterized formation parameters in order to select a drill bit design that performs according to the prioritization.

In an alternative embodiment drilling with an initially selected drill bit design might be modeled to determine performance of one or more performance characteristics. The drill bit design might be repeatedly modified to improve the performance of the one or more characteristics based upon the prioritization of the formation parameters. The drill bit design may also be optimized using repeated modeling. The modeling might be based upon a selected control model. The modeling might also be conducted so that certain constraints are established for certain performance parameters, for certain operating parameters, or for certain drill sting configuration parameters. For example, a model might be selected from a group of model types such as a cutter/formation control model, a weight on bit (WOB) control model, and rate of penetration control (ROP) control model. Alternatively, the modeling for the drill bit design might be based upon a constrained centerline model. In yet another alternative it might be based upon a dynamic model in which the centerline of the drill bit relative to the centerline of the bore hole during drilling is also determined and used in the determination of the various performance characteristics.

According to one embodiment of the invention the drill bit design may be improved or optimized with respect to the prioritization of the formation parameters by adjusting one or more drill bit design parameters for improved performance of particular performance characteristics for formations of interest having at least two identified formation characteristics and according to the prioritization of the formation characteristics or of prioritization of certain performance parameters according to the prioritization of the identified formation characteristics.

Bit design parameters may include any parameters that can be used to characterize a bit design. For example, bit design parameters provided as input include the cutter locations and orientations (e.g., radial and angular positions, heights, profile angles, back rake angles, side rake angles, etc.) and the cutter sizes (e.g., diameter), shapes (i.e., geometry) and bevel size. Additional bit design parameters may include the bit profile, bit diameter, number of blades on bit, blade geometries, blade locations, junk slot areas, bit axial offset (from the axis of rotation), cutter material make-up (e.g., tungsten carbide substrate with hardfacing overlay of selected thickness), etc. Those skilled in the art will appreciate that cutter geometries and the bit geometry can be meshed, converted to coordinates and provided as numerical input. Preferred methods for obtaining bit design parameters for use in a simulation include the use of 3-dimensional CAD solid or surface models for a bit to facilitate geometric input.

Therefore, by way of example, some of the drill bit design parameters that may be adjusted can include number of cutters, bit cutting profile, position of cutters on drill bit blades, bit axis offset of the cutters, bit diameter, cutter radius on bit, cutter vertical height on bit, cutter inclination angle on bit, cutter body shape, cutter size, cutter height, cutter diameter, cutter orientation, cutter back rake angle, cutter side rake angle, working surface shape, working surface orientation, bevel size, bevel shape, bevel orientation, cutter hardness, PDC table thickness, and cutter wear model. Table III below lists some of these drill bit design parameters.

TABLE III
Dill bit design parameters:

```
  1) blade angle,
  2) back rake angle of cutters,
  3) side rake angle of cutters,
  4) cutter placement on the blades,
  5) blade curvature,
  6) blade profile shape,
  7) number of cutters,
  8) bit cutting profile,
  9) position of cutters on drill bit blades,
10) bit axis offset of the cutter,
11) bit diameter,
12) cutter radius on bit,
13) cutter vertical height on bit,
14) cutter inclination angle on bit,
15) cutter body shape,
16) cutter size,
17) cutter height,
18) cutter diameter,
19) cutter orientation,
20) cutter back rake angle,
21) cutter side rake angle,
22) working surface shape,
23) working surface orientation,
24) bevel size,
25) bevel shape,
26) bevel orientation,
27) cutter hardness,
28) PDC table thickness, and
29) cutter wear model.
```

The modeling of drilling in the formation using a selected drill bit design or using a modified drill bit design may include simulating the drilling using the drill bit design to determine performance of the drill bit with respect to one or more performance characteristics. Performance characteristics and performance predicting characteristics may include selected from the group consisting of Total Imbalance Force (TIF), Side Rake Imbalance Force (SRIF), Beta angle (an angle between the radial force component and the circumferential force component of total imbalance force), centerline trajectory, blade contact, Rate Of Penetration (ROP), Weight On Bit (WOB), bottom hole pattern, torque on bit, forces on bit, imbalanced force components on bit, radial imbalanced force on bit, circumferential imbalanced force on bit, axial imbalanced force on bit, total imbalanced force on bit, vector angle of total imbalanced force on bit, imbalance of forces on blade, forces on blades, radial force on blades, circumferential force on blades, axial force on blades, total force on blade, vector angle of total force on blades, imbalance of forces on blade, cutter forces, cutter forces defined in a selected Cartesian coordinate system (x, y, and z), normal cutter force (Fn), cutting force (Fc), side force (Fs), total force on cutter (Ft), vector angle of total force, cutter forces defined in a polar coordinate system, radial cutter force, circumferential cutter force, axial cutter force, total force on cutter, vector angle of total force, imbalance of forces on cutter, back rake angle of cutter against the formation, side rake angle of cutter, cut shape on cutters, wear on cutters, contact of bit body with formation, impact force, restitution force, location of contact on bit or drill string, and orientation of impact force.

Some examples of performance characteristics that may be determined and that may be checked for improvement by adjusting the drill bit design or by adjusting the drill string design are set forth in Table IV below.

TABLE IV
Performance Characteristics:

| | |
|---|---|
| 1) | Total Imbalance Force (TIF), |
| 2) | Side Rake Imbalance Force (SRTF), |
| 3) | Beta angle (an angle between the radial |
| | force component and the circumferential force |
| | component of total imbalance force), |
| 4) | centerline trajectory, |
| 5) | blade contact, |
| 6) | Rate Of Penetration (ROP), |
| 7) | Weight On Bit (WOB), |
| 8) | bottom hole pattern, |
| 9) | torque on bit, |
| 10) | forces on bit, |
| 11) | imbalanced force components on bit, |
| 12) | radial imbalanced force on bit, |
| 13) | Circumferential imbalanced force on bit, |
| 14) | axial imbalanced force on bit, |
| 15) | total imbalanced force on bit, |
| 16) | vector angle of total imbalanced force on bit, |
| 17) | imbalance of forces on blade, |
| 18) | forces on blades, |
| 19) | radial force on blades, |
| 20) | circumferential force on blades, |
| 21) | axial force on blades, |
| 22) | total force on blade, |
| 23) | vector angle of total force on blades, |
| 24) | imbalance of forces on blade, |
| 25) | cutter forces |
| 26) | cutter forces defined in a selected |
| | Cartesian coordinate system (x, y, and z) |
| 27) | cutter forces defined in a polar coordinate system, |
| 28) | radial cutter force, |
| 29) | circumferential cutter force, |
| 30) | axial cutter force, |
| 31) | total force on cutter, |
| 32) | vector angle of total force, |
| 33) | imbalance of forces on cutter, |
| 34) | back rake angle of cutter against the formation, |
| 35) | side rake angle of cutter, |
| 36) | cut shape on cutters, |
| 37) | wear on cutters, |
| 38) | contact of bit body with formation, |
| 39) | impact force, |
| 40) | restitution force, |
| 41) | location of contact on bit or drill string, and |
| 42) | orientation of impact force. |

In one or more embodiments a drilling system design may be improved or might be optimized with respect to the prioritization of characterized formation parameters or optimized with respect to prioritization of performance characteristics by adjusting drill string design parameters. The drill string design parameters might, for example, include at least one of number of components, type of components, material of components, length, strength and elasticity of components, O.D. of components, I.D. of components, nodal division of components, type of down hole assembly, length, strength, elasticity, density, density in mud, O.D. and I.D. of down hole assembly, hook load, drill bit type, drill bit design parameters, length, diameter, strength, elasticity, O.D., I.D. and wear model of drill bit, number of blades, orientation of blades, shape, size strength, elasticity, OD, ID and wear model of blades. Such drill string design parameters are set forth in Table V below.

TABLE V
Drill string design parameters:

```
  1) number of components,
  2) type of components,
  3) material of components,
  4) length of components,
  5) strength of components,
  6) elasticity of components,
  7) O.D. of components,
  8) I.D. of components,
  9) nodal division of components,
10) type of down hole assembly,
11) length of down hole assembly
12) strength of down hole assembly
13) elasticity of down hole assembly
14) density of down hole assembly
15) density in mud of down hole assembly,
16) O.D. of down hole assembly
17) I.D. of down hole assembly,
18) hook load,
19) drill bit type,
20) drill bit design parameters,
21) length of drill bit,
22) diameter of drill bit,
23) strength of drill bit,
24) elasticity of drill bit,
25) O.D. of drill bit,
26) I.D. of drill bit,
27) wear model of drill bit,
28) number of blades,
29) orientation of blades,
30) shape of blades
31) size of blades
32) strength of blades
33) elasticity of blades
34) OD of blades
35) ID of blades and
36) wear model of blades.
```

It has been discovered by the inventors that in certain situations constraints are placed on the design by requirements of the drilling, availability of types of drill bits, the construction of existing drill strings to be used, or the drill bit operation parameters. Such constraints might, for example, establish minimum acceptable performance, establish requirements for maintaining at least certain drill bit design features, establish certain drill string design parameters, or establish drilling operation or drill bit operation parameters that it has been deemed must be maintained. Drilling parameters may include any parameters that can be used to characterize drilling. For example, drilling parameters might be provided as constraints might include the rate of penetration (ROP) or the weight on bit (WOB) and the rotation speed of the drill bit (revolutions per minute, RPM). Those having ordinary skill in the art would recognize that other parameters (e.g., mud weight) may be included.

Table VI sets forth examples of drilling and drill bit operation parameters.

TABLE VI
Drilling operation and drill bit operation parameters:

```
  1) weight on bit,
  2) bit torque,
  3) rate of penetration,
  4) rotary speed,
  5) rotating time,
  6) wear flat area,
  7) hole diameter,
  8) mud type,
  9) mud density,
10) vertical drilling,
11) drilling tilt angle,
12) platform/table rotation,
13) directional drilling,
14) down hole motor rotation,
15) bent drill string rotation, and
16) side load.
```

### Method for Simulating Drill Bit Design Performance

Any of a number of methods of modeling a selected drill bit design or an adjusted drill bit design drilling in an earth formation might be employed without departing from certain aspects of the present invention. A particular method of modeling the drilling is not required for certain aspects of the invention and those killed in the art will be able to model or simulate drilling according to a number of acceptable methods. In addition to the disclosures of methods that have been incorporated by reference above, examples of methods for simulation or modeling of drill bit performance in a given formation segment and drilling operation environment are provided here for completeness. For example, in one modeling method input data is entered or otherwise made available and the bottomhole shape determined, the steps in a main simulation loop can be executed. Within the main simulation loop, drilling is simulated by “rotating” the bit (numerically) by an incremental amount, Δθ_{bit,i}. The rotated position of the bit at any time can be expressed as,

$${θ}_{bit} = {\sum }^{i} {Δθ}_{bit , i} .$$

Δθ_{bit,i}, may be set equal to 3 degrees, for example. In other implementations, Δθ_{bit,i} may be a function of time or may be calculated for each given time step. The new location of each of the cutters is then calculated, based on the known incremental rotation of the bit, Δθ_{bit,i}, and the known previous location of each of the cutters on the bit. At this step, the new cutter locations only reflect the change in the cutter locations based on the incremental rotation of the bit. The newly rotated location of the cutters can be determined by geometric calculations known in the art. The axial displacement of the bit, Δd_{bit,i}, resulting for the incremental rotation, Δθ_{bit,i}, may be determined using an equation such as:

$$Δ {d}_{bit , i} = \frac{( {ROP}_{i} / {RPM}_{i} )}{360} \cdot ( Δ {θ}_{bit , i} ) .$$

Once the axial displacement of the bit, Δd_{bit,i}, is determined, the bit is “moved” axially downward (numerically) by the incremental distance, Δd_{bit,i}, (with the cutters at their newly rotated locations). Then the new location of each of the cutters after the axial displacement is calculated. The calculated location of the cutters now reflects the incremental rotation and axial displacement of the bit during the “increment of drilling.” Then, the interference of each cutter with the bottomhole is determined. Determining cutter interactions with the bottomhole includes calculating the depth of cut, the interference surface area, and the contact edge length for each cutter contacting the formation during the increment of drilling by the bit. These cutter/formation interaction parameters can be calculated using geometrical calculations known in the art.

Once the correct cutter/formation interaction parameters are determined, the axial force on each cutter during increment drilling step, i, is determined. The force on each cutter is determined from the cutter/formation interaction data based on the calculated values for the cutter/formation interaction parameters and cutter and formation information. The normal force, cutting force, and side force on each cutter is determined from cutter/formation interaction data based on the known cutter information (cutter type, size, shape, bevel size, etc.), the selected formation type, the calculated interference parameters (i.e., interference surface area, depth of cut, contact edge length) and the cutter orientation parameters (i.e., back rake angle, side rake angle, etc.). For example, the forces are determined by accessing cutter/formation interaction data for a cutter and formation pair similar to the cutter and earth formation interacting during drilling. Then, the values calculated for the interaction parameters (depth of cut, interference surface area, contact edge length, back rack, side rake, and bevel size) during drilling are used to look up the forces required on the cutter to cut through formation in the cutter/formation interaction data. If values for the interaction parameters do not match values contained in the cutter/formation interaction data, records containing the most similar parameters are used and values for these most similar records can be used to interpolate the force required on the cutting element during drilling.

The displacement of each of the cutters is calculated based on the previous cutter location. The forces on each cutter are then determined from cutter/formation interaction data based on the cutter lateral movement, penetration depth, interference surface area, contact edge length, and other bit design parameters (e.g., back rake angle, side rake angle, and bevel size of cutter). Cutter wear is also calculated for each cutter based on the forces on each cutter, the interaction parameters, and the wear data for each cutter. The cutter shape is modified using the wear results to form a worn cutter for subsequent calculations.

Once the forces, for example F_{N}, F_{cut}, and F_{side} on each of the cutters during the incremental drilling step are determined. These forces may be resolved into bit coordinate system, O_{ZRθ}, (axial (Z), radial (R), and circumferential (C). Then, all of the forces on the cutters in the axial direction are summed to obtain a total axial force F_{Z} on the bit. The axial force required on the bit during the incremental drilling step is taken as the weight on bit (WOB) required to achieve the given ROP or alternatively the ROP required to achieve a given WOB is determined.

The total force required on the cutter to cut through earth formation can be resolved into components in any selected coordinate system, such as a Cartesian coordinate system. The force on the cutter can be resolved into a normal component (normal force), F_{N}, a cutting direction component (cut force), F_{cut}, and a side component (side force), F_{side}. The cutting axis is positioned along the direction of cut.

The normal axis is normal to the direction of cut and generally perpendicular to the surface of the earth formation interacting with the cutter. The side axis is parallel to the surface of the earth formation and perpendicular to the cutting axis. The origin of this cutter coordinate system is positioned at the center of the cutter.

The bottomhole pattern is updated. The bottomhole pattern can be updated by removing the formation in the path of interference between the bottomhole pattern resulting from the previous incremental drilling step and the path traveled by each of the cutters during the current incremental drilling step.

Output information, such as forces on cutters, weight on bit, and cutter wear, may be provided for further analysis. The output information may include any information or data which characterizes aspects of the performance of the selected drill bit drilling the specified earth formations. For example, output information can include forces acting on the individual cutters during drilling, scraping movement/distance of individual cutters on hole bottom and on the hole wall, total forces acting on the bit during drilling, and the weight on bit to achieve the selected rate of penetration for the selected bit. Output information may be used to generate a visual display of the results of the drilling simulation. The visual display can include a graphical representation of the well bore being drilled through earth formations. The visual display can also include a visual depiction of the earth formation being drilled with cut sections of formation calculated as removed from the bottomhole during drilling being visually “removed” on a display screen. The visual representation may also include graphical displays of forces, such as a graphical display of the forces on the individual cutters, on the blades of the bit, and on the drill bit during the simulated drilling. The visual representation may also include graphical displays the dynamic centerline trajectory of the drill bit. The means, whether a graph, a visual depiction or a numerical table used for visually displaying aspects of the drilling performance can be a matter of choice for the system designer, and is not a limitation on the invention, According to one aspect of the invention it is useful to display the dynamic centerline trajectory of the drill bit during a period of time of simulated drilling.

As should be understood by one of ordinary skill in the art, with reference to co-owned co-pending U.S. patent application Ser. No 10/888,446, incorporated herein by reference in its entirety, the steps within a main simulation loop are repeated as desired by applying a subsequent incremental rotation to the bit and repeating the calculations in the main simulation loop to obtain an updated cutter geometry (if wear is modeled) and an updated bottomhole geometry for the new incremental drilling step. Repeating the simulation loop as described above will result in the modeling of the performance of the selected fixed cutter drill bit drilling the selected earth formations and continuous updates of the bottomhole pattern drilled. In this way, the method as described can be used to simulate actual drilling of the bit in earth formations.

An ending condition, such as the total depth to be drilled, can be given as a termination command for the simulation, the incremental rotation and displacement of the bit with subsequent calculations in the simulation loop will be repeated until the selected total depth drilled

$$( e . g . , D = {\sum }^{i} Δ {d}_{bit , i} )$$

is reached. Alternatively, the drilling simulation can be stopped at any time using any other suitable termination indicator, such as a selected input from a user or a desired output from the simulation.

Performance predicting parameters may include at least one of the group consisting of bottom hole pattern, forces on bit, torque, weight on bit, imbalanced force components, total imbalanced force on bit, vector angle of total imbalanced force on bit, imbalance of forces on blade, forces on blades, radial force, circumferential force, axial force, total force on blade, vector angle of total force, imbalance of forces on blade, forces on cutters, cutter forces defined in a selected Cartesian coordinate system, radial cutter force, circumferential cutter force, axial cutter force, an angle (Beta) between the radial force component and the circumferential force component of total imbalance force, total force on cutter, vector angle of total force, imbalance of forces on cutter, back rake angle of cutter against the formation, side rake angle, cut shape on cutters, wear on cutters, and contact of bit body with formation, impact force, restitution force, location of contact on bit or drill string, and orientation of impact force.

The simulating may include determining performance of the bit with respect to one or more performance characteristics selected from the group consisting of bottom hole pattern, forces on bit, torque, weight on bit, imbalanced force components in a selected Cartesian coordinate system, total imbalanced force on bit, vector angle of total imbalanced force on bit, imbalance of forces on blade, forces on blades, forces defined in a selected Cartesian coordinate system, total force on blade, vector angle of total force on blade, imbalance of forces on blade, forces on cutters, forces on the cutter defined in a selected Cartesian coordinate system, normal cutter force (Fn), cutting force (Fc), side force (Fs), total force on cutter (Ft), vector angle of total force, imbalance of forces on cutter, back rake angle of cutter against the formation, side rake angle, cut shape on cutters, wear on cutters, and contact of bit body with formation, impact force, restitution force, location of contact on bit or drill string, and orientation of impact force. Some of these examples of performance characteristics that may be determined and that may be checked for improvement by adjusting the drill bit design or by adjusting the drill string design are set forth in Table III above.

Drill bit design parameters are also provided as input and used to construct a model for the selected drill bit. Drill bit design parameters include, for example, the bit type such as a fixed-cutter drill bit and geometric parameters of the bit. Geometric parameters of the bit may include the bit size (e.g., diameter), number of cutting elements, and the location, shape, size, and orientation of the cutting elements. In the case of a fixed cutter bit, the drill bit design parameters may further include the size of the bit, parameters defining the profile and location of each of the blades on the cutting face of the drill bit, the number and location of cutting elements on each blade, the back rake and side rake angles for each cutting element. In general, drill bit, cutting element, and cutting structure geometry may be converted to coordinates and provided as input to the simulation program. In one or more embodiments, the method used for obtaining bit design parameters involves uploading of 3-dimensional CAD solid or surface model of the drill bit to facilitate the geometric input. Drill bit design parameters may further include material properties of the various components that make up the drill bit, such as strength, hardness, and thickness of various materials forming the cutting elements, blades, and bit body.

In one or more embodiments, drilling environment parameters include one or more parameters characterizing aspects of the wellbore. Wellbore parameters may include wellbore trajectory parameters and wellbore formation parameters. Wellbore trajectory parameters may include any parameter used in characterizing a wellbore trajectory, such as an initial wellbore depth (or length), diameter, inclination angle, and azimuth direction of the trajectory or a segment of the trajectory. In the typical case of a wellbore comprising different segments having different diameters or directional orientations, wellbore trajectory parameters may include depths, diameters, inclination angles, and azimuth directions for each of the various segments. Wellbore trajectory information may also include an indication of the curvature of each segment, and the order or arrangement of the segments in wellbore. Wellbore formation parameters may also include the type of formation being drilled and/or material properties of the formation such as the formation compressive strength, hardness, plasticity, and elastic modulus. An initial bottom surface of the wellbore may also be provided or selected as input. The bottomhole geometry maybe defined as flat or contour and provided as wellbore input. Alternatively, the initial bottom surface geometry may be generated or approximated based on the selected bit geometry. For example, the initial bottomhole geometry may be selected from a “library” (i.e., database) containing stored bottomhole geometries resulting from the use of various drill bits.

In one or more embodiments, drilling operation parameters might include the rotary speed (RPM) at which the drilling tool assembly is rotated at the surface and/or a downhole motor speed if a downhole motor is used. The drilling operation parameters also include a weight on bit (WOB) parameter, such as hook load, or a rate of penetration (ROP). Other drilling operation parameters may include drilling fluid parameters, such as the viscosity and density of the drilling fluid, rotary torque and drilling fluid flow rate. The drilling operating parameters may also include the number of bit revolutions to be simulated or the drilling time to be simulated as simulation ending conditions to control the stopping point of simulation. However, such parameters are not necessary for calculation required in the simulation. In other embodiments, other end conditions may be provided, such as a total drilling depth to be simulated or operator command.

In one or more embodiments, input may also be provided to determine the drilling tool assembly/drilling environment interaction models to be used for the simulation. As discussed in U.S. Pat. No. 6,516,293 and U.S. Provisional Application No. 60/485,642, cutting element/earth formation interaction models may include empirical models or numerical data useful in determining forces acting on the cutting elements based on calculated displacements, such as the relationship between a cutting force acting on a cutting element, the corresponding scraping distance of the cutting element through the earth formation, and the relationship between the normal force acting on a cutting element and the corresponding depth of penetration of the cutting element in the earth formation. Cutting element/earth formation interaction models may also include wear models for predicting cutting element wear resulting from prolonged contact with the earth formation, cutting structure/formation interaction models and bit body/formation interaction models for determining forces on the cutting structure and bit body when they are determined to interact with earth formation during drilling. In one or more embodiments, coefficients of an interaction model may be adjustable by a user to adapt a generic model to more closely fit characteristics of interaction as seen during drilling in the field. For example, coefficients of the wear model may be adjustable to allow for the wear model to be adjusted by a designer to calculate cutting element wear more consistent with that found on dull bits run under similar conditions.

Drilling tool assembly/earth formation impact, friction, and damping models or parameters can be used to characterize impact and friction on the drilling tool assembly due to contact of the drilling tool assembly with the wall of the wellbore and due to viscous damping effects of the drilling fluid. These models may include drill string-BHA/formation impact models, bit body/formation impact models, drill string-BHA/formation friction models, and drilling fluid viscous damping models. One skilled in the art will appreciate that impact, friction and damping models may be obtained through laboratory experimentation. Alternatively, these models may also be derived based on mechanical properties of the formation and the drilling tool assembly, or may be obtained from literature. Prior art methods for determining impact and friction models are shown, for example, in papers such as the one by Yu Wang and Matthew Mason, entitled “Two-Dimensional Rigid-Body Collisions with Friction,” Journal of Applied Mechanics, September 1992, Vol. 59, pp. 635-642.

Input data may be provided as input to a simulation program by way of a user interface which includes an input device coupled to a storage means, a data base and a visual display, wherein a user can select which parameters are to be defined, such as operation parameters, drill string parameters, well parameters, etc. Then once the type of parameters to be defined is selected, the user selected the component or value desired to be changed and enter or select a changed value for use in performing the simulation.

In one or more embodiments, the user may select to change simulation parameters, such as the type of simulation mode desired (such as from ROP control to WOB control, etc.), or various calculation parameters, such as impact model modes (force, stiffness, etc.), bending-torsion model modes (coupled, decoupled), damping coefficients model, calculation incremental step size, etc. The user may also select to define and modify drilling tool assembly parameters. First the user may construct a drilling tool assembly to be simulated by selecting the component to be included in the drilling tool assembly from a database of components and then adjusting the parameters for each of the components as needed to create a drilling tool assembly model that very closely represents the actual drilling tool assembly being considered for use.

In one embodiment, the specific parameters for each component selected from the database may be adjustable, for example, by selecting a component added to the drilling tool assembly and changing the geometric or material property values defined for the component in a menu screen so that the resulting component selected more closely matches with the actual component included in the actual drilling tool assembly. For example, in one embodiment, a stabilizer in the drilling tool assembly may be selected and any one of the overall length, outside body diameter, inside body diameter, weight, blade length, blade OD, blade width, number of blades, thickness of blades, eccentricity offset, and eccentricity angle may be provided as well as values relating to the material properties (e.g., Young's modulus, Poisson's ratio, etc.) of the tool may be specifically defined to more accurately represent the stabilizer to be used in the drilling tool assembly being modeled. Similar features may also be provided for each of the drill collars, drill pipe, cross over subs, etc., included in the drilling tool assembly. In the case of drill pipe, and similar components, additional features defined may include the length and outside diameter of each tool connection joint, so that the effect of the actual tool joints on stiffness and mass throughout the system can be taken into account during calculations to provide a more accurate prediction of the dynamic response of the drilling tool assembly being modeled.

The total force required on the cutter to cut through earth formation can be resolved into components in any selected coordinate system, such as a Cartesian coordinate system. For example, the force on the cutter can be resolved into a normal component (normal force), F_{N}, a cutting direction component (cut force), F_{cut}, and a side component (side force), F_{side}. In a cutter coordinate system, the cutting axis is positioned along the direction of cut. The normal axis is normal to the direction of cut and generally perpendicular to the surface of the earth formation interacting with the cutter. The side axis is parallel to the surface of the earth formation and perpendicular to the cutting axis. The origin of such a cutter coordinate system might be positioned at the center of the cutter.

As previously stated, other information is also recorded for each cutter/formation test to characterize the cutter, the earth formation, and the resulting interaction between the cutter and the earth formation. The information recorded to characterize the cutter may include any parameters useful in describing the geometry and orientation of the cutter. The information recorded to characterize the formation may include the type of formation, the confining pressure on the formation, the temperature of the formation, the compressive strength of the formation, etc. The information recorded to characterize the interaction between the selected cutter and the selected earth formation for a test may include any parameters useful in characterizing the contact between the cutter and the earth formation and the cut resulting from the engagement of the cutter with the earth formation.

Those having ordinary skill in the art will recognize that in addition to the single cutter/formation model explained above, data for a plurality of cutters engaged with the formation at about the same time may be stored. In particular, in one example, a plurality of cutters may be disposed on a “blade” and the entire blade be engaged with the formation at a selected orientation. Each of the plurality of cutters may have different geometries, orientations, etc. By using this method, the interaction of multiple cutters may be studied. Likewise, in some embodiments, the interaction of an entire PDC bit may be studied. That is, the interaction of substantially all of the cutters on a PDC bit may be studied.

In particular, in one embodiment of the invention, a plurality of cutters having selected geometries (which may or may not be identical) are disposed at selected orientations (which may or may not be identical) on a blade of a PDC cutter. The geometry and the orientation of the blade are then selected, and a force is applied to the blade, causing some or all of the cutting elements to engage with the formation. In this manner, the interplay of various orientations and geometries among different cutters on a blade may be analyzed. Similarly, different orientations and geometries of the blade may be analyzed. Further, as those having ordinary skill will appreciate, the entire PDC bit can similarly be tested and analyzed.

In one example, a record of data stored for an experimental cutter/formation test may be used to characterize cutter geometry and orientation including back rake angle, side rake angle, cutter type, cutter size, cutter shape, and cutter bevel size, cutter profile angle, the cutter radial and height locations with respect to the axis of rotation, and a cutter base height. The information stored in the record to characterize the earth formation being drilled may also include the type of formation. The record may additionally include the mechanical and material properties of the earth formation to be drilled, but it is not essential that the mechanical or material properties be known to practice the invention. The record may also include data characterizing the cutting interaction between the cutter and the earth formation during the cutter/formation test, including the depth of cut, d, the contact edge length, e, and the interference surface area, a. The volume of formation removed and the rate of cut (e.g., amount of formation removed per second) may also be measured and recorded for the test. The parameters used to characterize the cutting interaction between a cutter and an earth formation will be generally referred to as “interaction parameters”.

In one embodiment, the cuts formed into an earth formation during the cutter/formation test are digitally imaged. The digital images may subsequently be analyzed to provide information about the depth of cut, the mode of fracture, and other information that may be useful in analyzing fixed cutter bits.

Depth of cut, d, contact edge length, e, and interference surface area, a, for a cutter cutting through earth formation. The depth of cut or, d is the distance below the earth formation surface that the cutter penetrates into the earth formation. The interference surface area, a, is the surface area of contact between the cutter and the earth formation during the cut. Interference surface area may be expressed as a fraction of the total area of the cutting surface, in which case the interference surface area will generally range from zero (no interference or penetration) to one (full penetration). The contact edge length, e, is the distance between furthest points on the edge of the cutter in contact with formation at the earth formation surface.

The data stored for the cutter/formation test uniquely characterizes the actual interaction between a selected cutter and earth formation pair. A complete library of cutter/formation interaction data can be obtained by repeating tests as described above for each of a plurality of selected cutters with each of a plurality of selected earth formations.

Laboratory tests may be performed for other selected earth formations to accurately characterize and obtain numerical models for each earth formation and additional numerical cutter/formation tests are repeated for different cutters and earth formation pairs and the resulting data stored to obtain a library of interaction data for different cutter and earth formation pairs. The cutter/formation interaction data obtained from the numerical cutter/formation tests are uniquely obtained for each cutter and earth formation pair to produce data that more accurately reflects cutter/formation interaction during drilling.

In addition, library of data may include multilayered formations or inhomogeneous formation data. In particular, actual rock samples or theoretical models may be constructed to analyzed inhomogeneous or multilayered formations. In one embodiment, a rock sample from a formation of interest (which may be inhomogeneous), may be used to determine the interaction between a selected cutter and the selected inhomogeneous formation. In a similar vein, the library of data may be used to predict the performance of a given cutter in a variety of formations, leading to more accurate simulation of multilayered formations.

As previously explained, it is not necessary to know the mechanical properties of any of the earth formations for which laboratory tests are performed to use the results of the tests to simulate cutter/formation interaction during drilling. The data can be accessed based on the type of formation being drilled. However, if formations which are not tested are to have drilling simulations performed for them, it is preferable to characterize mechanical properties of the tested formations so that expected cutter/formation interaction data can be interpolated for untested formations based on the mechanical properties of the formation. As is well known in the art, the mechanical properties of earth formations include, for example, compressive strength, Young's modulus, Poisson's ration and elastic modulus, among others. The properties selected for interpolation are not limited to these properties.

The use of laboratory tests to experimentally obtain cutter/formation interaction may provide several advantages. One advantage is that laboratory tests can be performed under simulated drilling conditions, such as under confining pressure to better represent actual conditions encountered while drilling. Another advantage is that laboratory tests can provide data which accurately characterize the true interaction between actual cutters and actual earth formations. Another advantage is that laboratory tests can take into account all modes of cutting action in a formation resulting from interaction with a cutter. Another advantage is that it is not necessary to determine all mechanical properties of an earth formation to determine the interaction of a cutter with the earth formation. Another advantage is that it is not necessary to develop complex analytical models for approximating the behavior of an earth formation or a cutter based on the mechanical properties of the formation or cutter and forces exhibited by the cutter during interacting with the earth formation.

Cutter/formation interaction models as described above can be used to provide a good representation of the actual interaction between cutters and earth formations under selected drilling conditions.

Cutter/formation interaction data includes data obtained from experimental tests or numerically simulations of experimental tests which characterize the actual interactions between selected cutters and selected earth formations, as previously described in detail above. Wear data may be data generated using any wear model known in the art or may be data obtained from cutter/formation interaction tests that included an observation and recording of the wear of the cutters during the test. A wear model may comprise a mathematical model that can be used to calculate an amount of wear on the cutter surface based on forces on the cutter during drilling or experimental data which characterizes wear on a given cutter as it cuts through the selected earth formation. U.S. Pat. No. 6,619,411 issued to Singh et al. discloses methods for modeling wear of roller cone drill bits. This patent is assigned to the present assignee and is incorporated by reference in its entirety. Other patents related to wear simulation include U.S. Pat. Nos. 5,042,596, 5,010,789, 5,131,478, and 4,815,342. The disclosures of these patents are incorporated by reference in their entireties.

Drilling parameters may include any parameters that can be used to characterize drilling. In the method shown, the drilling parameters provided as input include the rate of penetration (ROP) or the weight on bit (WOB) and the rotation speed of the drill bit (revolutions per minute, RPM). Those having ordinary skill in the art would recognize that other parameters (e.g., mud weight) may be included.

### EXAMPLES SECTION

### Example 1

In a first example, FIG. 4, shows a well log 340 for a formation of interest. The formation includes a first formation segment 344, a second formation segment 346, and a third formation segment 348. Data displayed in this well log, or similar data, by which the formation segments can be characterized, can be gathered from a variety of possible sources such as drilling run reports, drill bit dull photos, drill bit dull records, formation records, rock strength data, parameters of previous drilling runs, and previous BHA designs.

Characterizing the combination of segments to be drilled includes noting certain challenging characteristics such as a wide range of formation types (Limestone, dolomite, clay, sand, and anhydrite) and a resulting wide range of values for the unconfined compressive strength (UCMPS) of the various segments. In this case the range of UCMPS is from about <500 psi to 27,000 psi. In addition it is noted that some of the formation segments are formations of softer matrix rock with harder rock interbedded in the softer matrix. Such interbedded formations are known to have a high potential for torsional/slip-stick and a resulting potential for impact damage to the PDC cutters on the drill bit.

While the first segment is the longest segment (about 1100 meters) it also consists generally of the softest rock types (limestone, dolomite, and shale) with UCMPS (ranging from about 500 psi to 12,000 psi. The second segment is the next longest segment (about 750 meters) and includes the hardest rock formation with the greatest UCMPS (ranging from about 12,000 psi to 27,000 psi) and also the most difficult to drill interbedded formation materials including extremely hard and interbedded carbonate, limestone, and shale. The third segment is relatively shorter (about 350 meters) and includes abrasive sandstone with a wide range of UCMPS (about 6000 psi to 17500 psi). The third abrasive segment also is positioned at the end of the drilling run so that wear during the entire run or deterioration that exacerbates wear may significantly reduce the likelihood of a successful drilling run to the total depth TD.

In this example, prioritizing the performance characteristics based upon the characterized formation segments indicates that as a first priority, durability must be maximized for the significantly long sections of limestone and hard carbonate drilling specifically for the interbedded second section. As a second priority, a blend of durability and ROP potential must be achieved to give the best performance for the long first section of low compressive strength limestone, dolomite and shale. As a third priority the drill bit must have enough wear resistance to drill through the upper portions and also continue to drill through the very abrasive third segment without failure due to wear at the end of the run.

In this example, a drill bit design that is known to have a good stability in hard interbedded formations, decent ROP in softer limestone, dolomite, and shale formation and that resist wear may be selected as the drill bit design based upon the forgoing formation characterizing and performance prioritizing.

Some of the considerations for characterizing the formation segments and prioritizing the performance characteristics will be discussed below. Some of these considerations can also be useful for determining which drill bit design parameters possibly to adjust to improve the performance of the selected drill bit design based upon the characterizing of the formation segments and the prioritizing of performance parameters. For example, an analysis might include an inquiry into the possible causes of performance problems in this same formation in prior runs. Consideration might be given to previous ROP, footage, tool face control, and drill bit dull condition at the depth at which prior tools failed or were withdrawn. Identifying which formations are critical to the completion of a run to the TD is useful. Identifying major failure modes for critical formations may also be useful. Identifying rock mechanics for each section in the critical formations can further be useful. An analysis of baseline information from bits already run or from competitor baseline bit information if it is available can also be useful. Possible design solutions based upon previous experience and data can be usefully compiled, recorded, and/or programmed for consideration, contrasting and comparison. The various existing tools available and the performance characteristics known for such tools can also be compiled, recorded, and/or compared with the prioritized performance characteristics within a computer using an appropriately programs or software. Iterations can be done on the computer instead of in the field. Faster advancement through better understanding of mechanisms affecting bit behavior is achieved.

Other factors that might facilitate the prioritization or that might act as constraints or “must have” characteristics or parameters for the simulation of a selected drill bit design can include the drilling company's goals and operating constraints or self imposed constraints such as drilling footage to be achieved with the drill bit run, the ROP, and the durability.

In the process of selecting a drill bit design, it was noted that shoulder areas of PDC drill bits are often susceptible to damage in hard formations. Thus, in the example shown, to facilitate reduced susceptibility to cutter damage a single set drill bit design can be selected as one that would give better distribution of cutting forces of the shoulder area of the drill bit. It is also noted that a drill bit having cutters positioned on the blades with non-aggressive back rake angles may be selected to both provide stable drilling, less potential for slip/stick drilling and to protect the cutter tips from damage during drill hard formations segments and during any potential slip/stick situations. An aggressive back rake angle for the cutters would normally provide better or optimum ROP in the soft formation. However, the ROP is the second priority performance characteristic and therefore can yield to the first priority performance characteristic. In this example, the less aggressive back rake angles reduce the ROP only slightly, and continue to sustain reasonably good ROP. To address the wear situation that is the third priority performance characteristic in this example, it might be noted that a certain wear area may be predicted on various cutter faces. Data has shown that the wear area will generally be the same for small diameter cutters and for large diameter cutters in the same positions on the drill bit. For a larger diameter cutter the same total wear area is a smaller percentage of the total cutter face surface. Thus, in a proposed selected drill bit design, 19 mm diameter cutters are substituted for 16 mm cutters particularly in locations on the drill bit expected to have large amounts of wear. The larger diameter cutter also is also consistent with the first priority and the third priority because it both improves durability against impact in the second segment of the formation and also increases the diamond volume to reduce the negative effect of wear in the third segment of the formation and the later portion of the drill run. Thus, a single set drill bit design, with cutters having non-aggressive back rake angles, and cutters having large diameter diamond faces may be selected to provide a good combination of durability, ROP and wear resistance in the order of priority for the formation of interest.

Upon selecting a drill bit design, the design can be modeled or simulated as drilling in the formation of interest. In this process constraints can be established and the during the modeling simulation, the design can be checked to confirm that the constraints are maintained while verifying that the drill bit design meets the performance priorities. In the event the selected design does not meet the priorities or in the event that improvement or optimization is desired, complex interactions of the bit, BHA, and drive system can be measured and designs can be modified to meet the constraints and/or to improve and /or to optimize the design based upon the prioritized performance characteristics. Modifications to minor design parameters can provide step changes that might be made and tried via modeling or simulation repeatedly until desired improved performance or optimized performance is obtained according to the prioritization. In certain instances radical design changes might also be applied and the resulting performance determined via modeling.

### Example 2

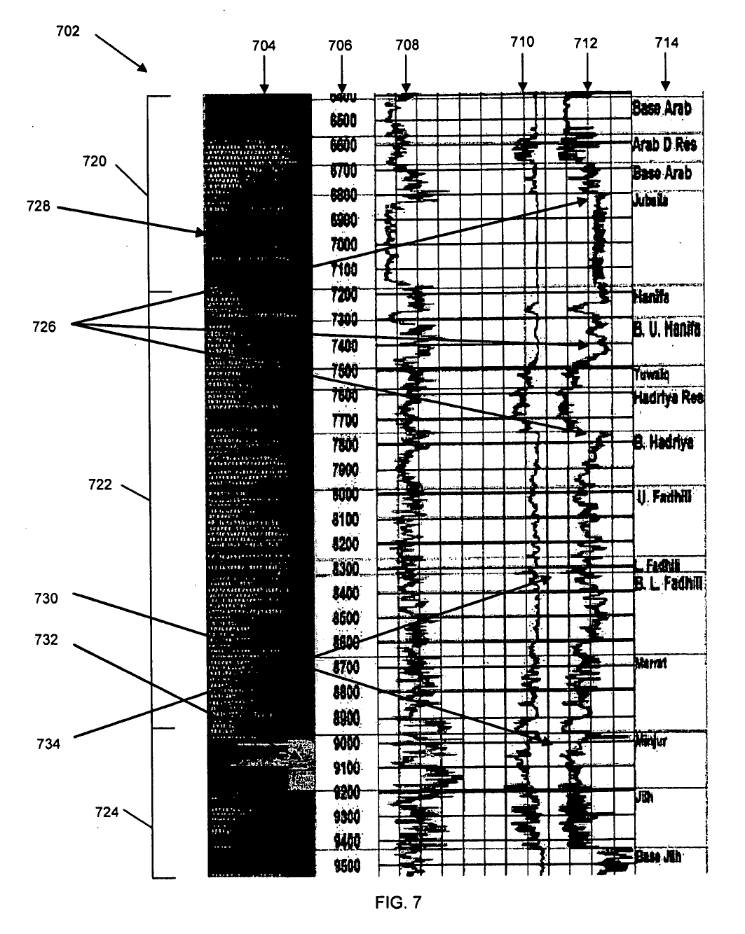

In another example, a formation of interest 700 is represented in FIG. 7 by a well log 702. The well log shows formation rock types at 704, depth at 706, gamma wave investigation data at 708, sonic wave propagation investigation at 710, the unconfined compressive strength 712, and names given to various portions of the formation. Generally speaking the formation may be divided into multiple formation segments 720, 722, and 724. In the present example, the formation of interest is primarily the depicted middle segment 722 extending sequentially below an upper portion 720 and above a lower portion 724.

The middle segment 722 may be characterized as including several portions of high compressive strength rock formations indicated by arrows at 726. There are also portions of reasonably high compressive strength 730. These portions correspond to the indication of a presence of sandstone at 732. The combination of high compressive strength and sandstone indicate a characterization of significant abrasiveness. Another portion is characterized as extending a significant distance (from about 7800 meters deep to about 8950 meters deep) and consists of generally softer rock formations.

A performance characteristics that are likely to be relevant include stability drilling in the high compressive strength portion 726, wear resistance in the abrasive sandstone portion identified at 730 and 732, and stability drilling in the relatively softer rock formation for a significant length. To prioritize the identified performance characteristics in this example it may be considered that if the drill bit design does not provide for successful penetration of the hard formation portions at the top of the formation of interest or if chipping occurs, the remainder of the drilling is also not likely to be successful without tripping the tool out and replacing it. Thus, the stability while drilling in the hard formation may be prioritized as a first priority above the characteristic of durability and ROP when drilling a long distance in the softer second segment of the formation, and above the characteristic of wear resistance for drilling in the abrasive second segment of the formation. The desire to drill rapidly and without significant damage to the drill bit for the long portion in the second segment is important and thus prioritized above some of the other possible performance characteristics. The wear resistance is also important for purposes of reaching the desired total drilling depth TD. Because the relatively softer rock formation will likely be drillable with a larger variety of designs and because failure due to wear in the deeper sandstone portion can result, not only in slower drilling, but can also result in additional trip time if the drill bit does not drill to the TD. Thus, the wear performance characteristic is prioritized as the second priority and the stability and ROP in the softer rock formation at 734 are prioritized as third and fourth priority. It may be difficult to rank the third and fourth priorities relative to each other so they might be considered of equal importance without departing from certain aspects of the invention.

In the present example certain constraints may be applied. For example the borehole may be required to be 16 inches in diameter. Other constraints might be imposed on the drilling run such as requiring a particular weight on the drill bit (for example 35 klbs WOB), requiring a particular drill rotation speed (for example 180 RPM), or requiring both a designated WOB and RPM. When the drilling is modeled these operating constraints may be input into the model for simulation. It will be noted that performance constraints might also be established such as requiring a rate of penetration (ROP) equal to or greater than 25 ft/hour. Such performance constraints can be checked after each modification of the drill bit design and each repeated simulation.

In this example one or more possible drill bit designs can be selected. One design can be selected and simulated to determine whether the drill bit design meets the prioritization criteria. The design might be modified step wise to improve the performance of the prioritized performance characteristics or a radical change may be made such as radically replacing one design with another design to see which design has better performance according to the prioritized performance characteristics or to see which design otherwise improves the performance according to the prioritization better than another design. the process can be repeated to select among several drill bit designs according to the performance priorities.

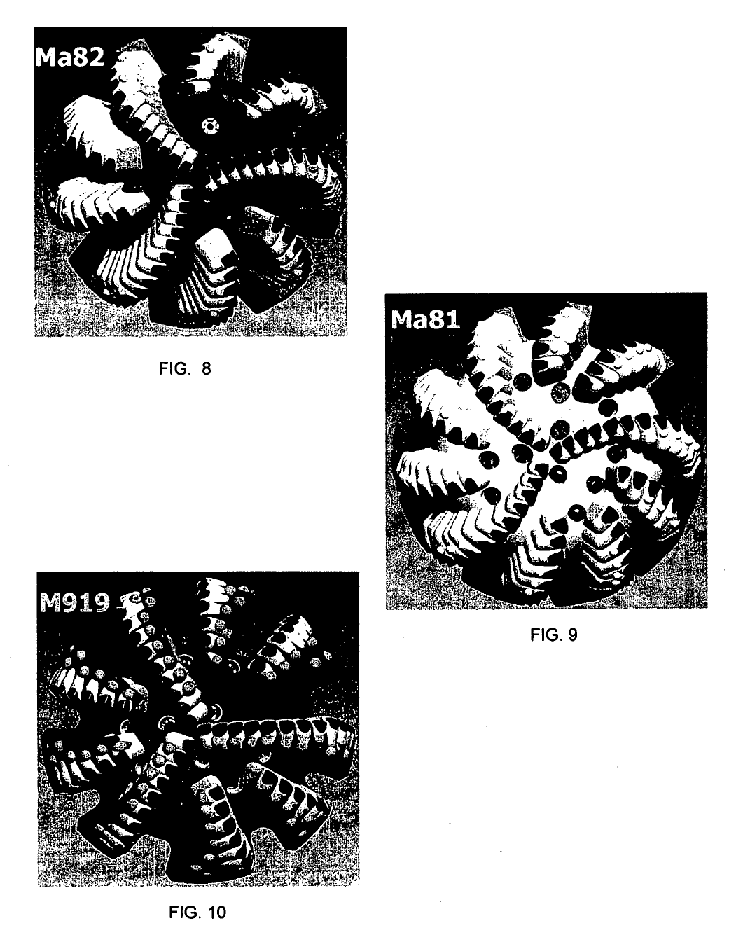

FIG. 8 shows a drill bit design designated “Ma82”. In the Ma82 design there are 9 blades, 19 mm/16 mm arcs design cutters, the cutter blade arrangement is designated as a 3-2 trail opposing plural set layout. The cutter back rake angles at the face are at 15 degrees, at the nose 20 degrees, at the shoulder 25 degrees, and at the gage 30 degrees.

FIG. 9 shows a drill bit design designated “Ma81”. In the Ma81 design there are 10 blades, 19 mm/16 mm arcs design cutters, the cutter blade arrangement is designated as a 5-2 opposing plural set layout. The cutter back rake angles at the face are at 12 degrees, at the nose 18 degrees, at the shoulder 22-25 degrees and at the gage 30 degrees.

FIG. 10 shows a drill bit design designated “M919 ER20585”. In the M919 ER20585 design there are 9 blades, 19 mm cutters, the cutter blade arrangement is designated as a single set layout, and the radial cut sequence is defined as a reverse radial sequence with 75 cutters positioned at the face of the drill bit and 10 cutters at the gage. The cutter back rake angles at the face are at 20-25 degrees, at the nose 20-22 degrees, at the shoulder 22-25 degrees and at the gage 30 degrees.

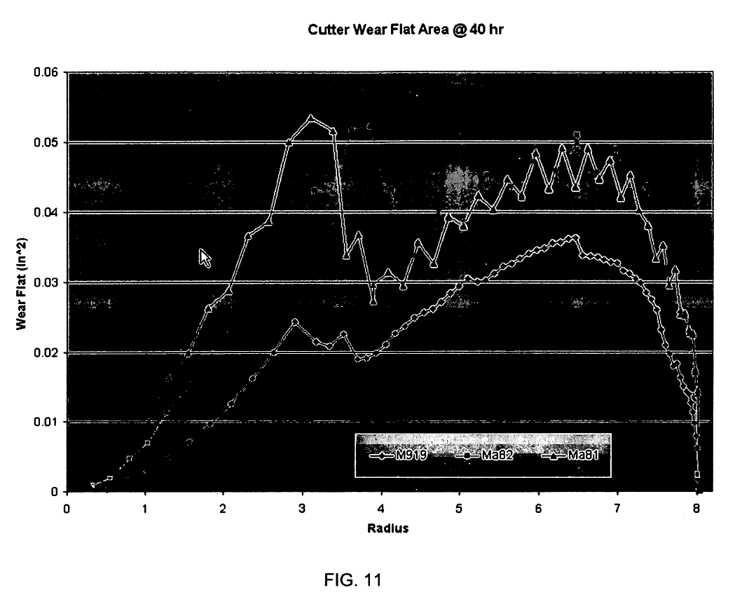

FIG. 11 shows a diagram comparing the cutter wear flat areas for each of the three designs Ma82, Ma81 and M919 after 40 hours of simulated drilling. The wear is indicated for cutters positioned at the indicated radii. The wear analysis shows that for large diameter bits run at higher speeds it becomes important to use higher back rakes, such as those associated with the M919 design, in order to maintain small wear flats on the shoulder of the bit. Gains in ROP from shallow back rake are quickly diminished because of wear flat growth.

FIG. 12 shows a diagram comparing the footage In the footage analysis, the distance drilled is determined by stopping the calculations when a number of shoulder cutters have passed 0.035 wear flat. The single set bit with larger back rakes should be more durable and drill further than previous bits.

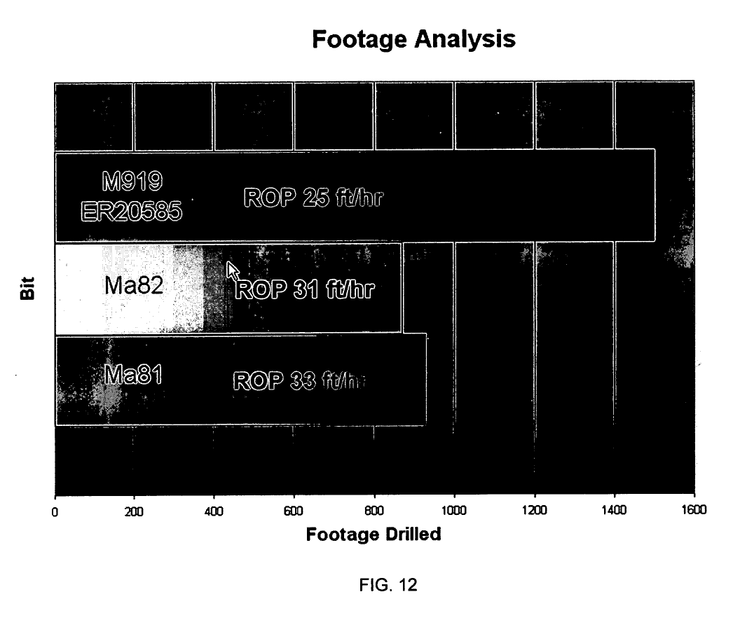

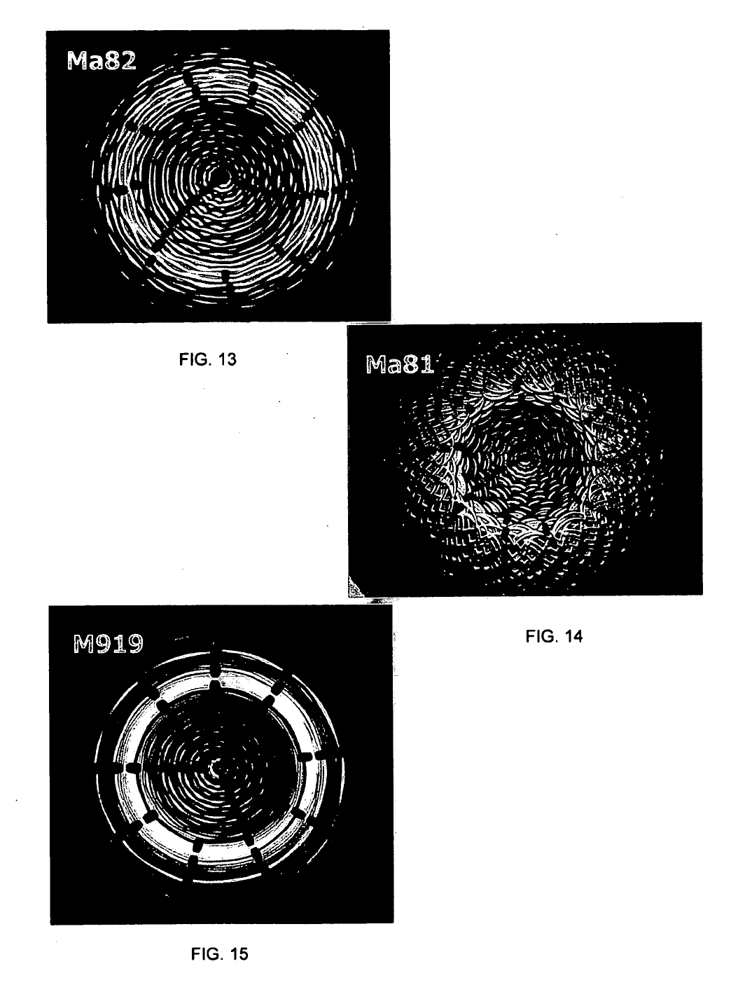

FIGS. 13, 14, and 15 show simulated bottom hole patterns for the drill bit designs Ma82, Ma81, and M919 respectively. The bottom hole patterns were generated using 35,000 lb WOB, 120 rpm on the motor and 60 rpm on the drill string (a total of 180 RPM at the dill bit). The bottom hole patterns in the formation indicated are generally representative of the performance in various other hardness of formations. The drill bit designs can also be tested in a range of ROP, for example from about 130 RPM to 220 RPM, and a range of WOB, for example WOB from about 20 klbs to 40 klbs to check for stability in a wide range of parameters.

Although bottom hole patterns are not perfect in all formations, the dynamic analysis shows that the drill bit design labeled M919 should be much more stable than the Ma82 or the Ma81 designs. Above about 180 RPM, stability in this example can become much more difficult to achieve. M919 is shown to have very good behavior over the widest parameter range. Ma82 is shown to have good behavior under some conditions. Ma81 show is shown to have poor behavior under almost all conditions

The high compressive strength portions of the formation of interest will likely require a drill design having good stability in hard formations. Thus the bottom hole pattern showing a smooth dynamic cutting patters for most of the cutters indicates good stability performance as meeting the first priority. The wear flat analysis also indicates that the second priority of wear resistance is accommodated best by the M919 drill bit design. Although the rate of penetration for the M919 drill bit design is not as aggressive as the other designs the rate of 25 ft. per hour is within the constraint range. Moreover, a comparison of the total footage before reaching the 0.035 wear flat area shows that the M919 design drills deeper than the other designs. Thus, according to this example, the priorities of stability (first), wear resistance (second), and adequate drilling durability in softer formations (third) are provided by selecting and/or adjusting to obtain the M919 drill bit design.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for designing a drill bit, comprising:
characterizing a plurality of formation segments,
identifying relevant performance characteristics for drilling in the characterized formation segments,
prioritizing at least two of the identified relevant performance characteristics based upon the characterization of the formation segments, and
selecting a bit design based upon the prioritizing.

2. The method of claim 1 further comprising modifying the selected drill bit design to improve the at least two identified performance characteristics based upon the prioritizing.

3. The method of claim 2 wherein the modifying comprises adjusting the selected drill bit design to improve the at least two identified performance characteristics based upon the prioritizing.

4. The method of claim 3 further comprising:
establishing constraints on one or more performance characteristics,
checking the one or more performance characteristics of the modified bit design for compliance with the established constraints.

5. The method of claim 2 wherein the modifying the selected drill bit design comprises:
simulating the drilling of the at least two characterized formation segments with a drill bit having the selected design,
determining performance for at least two of the identified performance characteristics based upon the simulation,
adjusting at least one design parameter to provide a modified design,
checking for improvement in the performance of the least two identified performance characteristic; and
repeating the simulating, determining, and adjusting at least until performances of the at least two prioritized performance characteristic are improved according to the prioritizing.

6. The method of claim 5 further comprising:
establishing constraints on one or more performance characteristics,
checking the performance for one or more performance characteristics of the modified bit design for compliance with the established constraints, and
repeating the simulating, determining, and adjusting at least until performances of the one or more performance characteristics are in compliance with the established constraints.

7. The method of claim 1 further comprising:
establishing constraints on one or more performance characteristics,
simulating the drilling of the at least two characterized formation segments with a drill bit having the selected design,
determining performance for at least two of the identified performance characteristics based upon the simulation, and
checking the one or more performance characteristics of the selected bit design for compliance with the established constraints.

8. The method of claim 7 further comprising modifying the selected drill bit design so the one or more performance characteristics comply with the established constraints.

9. The method of claim 8 further comprising modifying the selected drill bit design to improve the performance of the at least two identified performance characteristics based upon the prioritizing.

10. The method of claim 1 wherein the characterization of the formation segments comprises characterizing the formation segments for a drilling field of interest based upon one or more of the group comprising formation records, bit run records, customer formation data, experimental data, and other well data in the same or similar drilling field of interest.

11. The method of claim 10 wherein the formation segments are characterized as one or more of the group of characterizations including hard formation, medium hard formation, soft formation, abrasive formation, medium hard and abrasive formation, soft and abrasive formation, transition formation, and conglomerate formation.

12. The method of claim 10 wherein the characterization of the formation segments comprises determining the proportion of a drilling run that will be one or more of the group of hard formation, medium hard formation, soft formation, abrasive formation, medium hard and abrasive formation, soft and abrasive formation, transition formation, and conglomerate formation.

13. The method of claim 1 wherein the at least two relevant performance characteristics are selected from among the group of stability, wear, peak loads, and drilling deviation.

14. The method of claim 1 wherein the identification of relevant performance characteristics comprises identification of one or more of the group selected from wear patterns, historical failure modes, dull bit grading, stability analysis, impact loads, peak cutter loads, rate of penetration (ROP), rotation speed (RPM), and depth of cut (DOC).

15. A method of designing a drill bit, comprising:
selecting an initial drill bit design;
characterizing a plurality of formation segments for a formation of interest,
identifying at least two relevant performance characteristics for drilling in the characterized formation segments,
prioritizing the at least two relevant performance characteristics based upon the characterization of the formation segments, and
modifying the selected bit design based upon the prioritizing.

16. A method of planning well drilling comprising:
characterizing a plurality of formation segments,
identifying relevant performance characteristics for drilling in the characterized formation segments,
prioritizing at least two of the identified relevant performance characteristics based upon the characterization of the formation segments, and
selecting at least one bit design based upon the prioritizing.

17. The method of planning well drilling of claim 16 wherein the selecting the at least one drill bit based upon the prioritizing comprises selecting more than one drill bit design and determining a sequence of drilling with the selected more than one drill bit design to improve the at least two relevant performance characteristics during drilling.

18. A system for prioritizing formation characteristics comprising storing formation type identifications on a database, storing previously prioritized performance characteristics for the identified formation types on a database, storing drill bit designs previously optimized for the prioritized performance characteristics, matching input formation type identifications with the prioritized characteristics and with the drill bit designs, and outputting at least one matched drill bit design.

19. A fixed cutter drill bit designed by the method of claim 1.

20. A fixed cutter drill bit designed by the method of claim 15.
